(19) United States
(12) Patent Application Publication
(10) Pub. No.: US 2016/0364796 A1
(43) Pub. Date: Dec. 15, 2016

(54) DATABASE MANAGEMENT CONCEPTS FOR FACILITATING INTERCREDITOR COLLATERAL SHARING

(71) Applicant: Entaire Global Intellectual Property, Inc., Atlanta, GA (US)

(72) Inventors: Jonathan D. Rosen, Atlanta, GA (US); Timothy P. Veith, Atlanta, GA (US)

(21) Appl. No.: 15/178,933

(22) Filed: Jun. 10, 2016

Related U.S. Application Data
(60) Provisional application No. 62/175,025, filed on Jun. 12, 2015.

(51) Int. Cl. G06Q 40/02; G06F 17/30

(52) U.S. Cl. CPC G06Q 40/025; G06F 17/30289

(57) ABSTRACT

Various embodiments of the present invention are directed to database management concepts for reflecting the sharing of collateral among multiple debt products. In various embodiments, collateral instruments used to secure a plurality of debt products are pledged to a collateral agent, who may deposit the debt products into a collateral account. The system may receive data regarding characteristics of the pledged collateral instruments and the associated debt products. The data regarding the debt products may indicate collateral allocation requirements for each of the plurality of debt products, the collateral allocation requirements specifying collateral instrument characteristics necessary for a particular collateral instrument to secure the debt product. Based on the received data, a collateral allocation may be determined, under which data corresponding to each of the pledged collateral instruments may be linked with data corresponding to one or more debt products and utilized to secure the debt products.

### CROSS-REFERENCE TO RELATED APPLICATIONS

This patent application is related to Provisional Application Ser. No. 62/175,025, filed Jun. 12, 2015, which is incorporated herein by reference in its entirety.

### BACKGROUND

The term “asset backed securitization” commonly describes a complex financial instrument or debt product that combines either tangible assets (e.g., cars, machinery, inventory) and/or intangible assets (e.g., loans, mortgages or credit card receivables) for remarketing to investors in different tiers or tranches that may be indicative of the level of risk associated with an investment in the instrument. These instruments and products can be secured by virtually any type of underlying asset. By combining similarly situated assets into a larger pool, an issuer of such an asset backed securitization (ABS) is able to structure the ABS to a certain risk profile based on characteristics of the applicable asset pool. Typical risk profiles assess factors such as the inherent risk of default, regulatory equity requirements, degradation asset value, timing of investment realization, relative comparative size of assets in the pool, and other defined characteristics. The ABS issuer creates liquidity by diversifying risk among debt and equity investors who are looking to match investment objectives with overall risk profiles within the asset pool class. Repackaging loans through these financial instruments and products creates a variety of risk profiles that financial investors demand (e.g., AAA, AA, BBB, BB, B, residual), and the structure can tailor the timing and payout of returns based upon the investors' respective requirements. Investors purchase portions of these ABSs that meet their individual requirements and objective, which take many differing forms, such as shares, bonds, notes or other securities (“ABS securities”). Securitization transactions permit broad diversification of the risk profiles of the underlying assets that is not possible without pooling of assets.

Institutional investors, such as banks, insurance companies, pension funds, and investment funds, invest in ABS Securities. Typically, an institutional sized conduit lender provides the institutional investors (“securitization investors”) the opportunity to invest in a securitization. In a typical transaction, a finance lender makes a loan to an individual retail or commercial borrower secured with assets pledged by the borrower through an underlying loan agreement. The finance lender issues the proceeds under the loan agreement through an entity borrower known as a special purpose vehicle (SPV), with contractual provisions designed to make this entity remote from its owners, the finance lender, under bankruptcy law. The finance lender creates a credit agreement that defines the characteristics, terms and conditions of the ABS securities that will be marketed, including the requirements for collateral, equity, risk tolerances and qualifications characteristics, for the conduit lender and the securitization investors, and the parties enter into a securitization agreement that memorializes the structure. In order for the ABS securities transaction to be successful, the terms of the credit agreement and the securitization agreement must be aligned as to the type of collateral, loan length, method of perfecting collateral security interests, repayments, defaults, termination provisions and other terms typical of a securitization transaction.

Existing systems and methods require the collateral for a given securitization agreement and the related credit agreement to identify one or more specific items or collateral instruments utilized as security for the ABS securities, but with little or no variation permitted if the collateral does not meet the defined characteristics. Collateral substitution may be altogether prohibited or require an amendment to the applicable securitization agreement and related credit agreement. Often times, these agreements may prohibit such modifications or, alternatively, modifications may be impossible or cost and time prohibitive due to the large number of parties required to consent.

Some historical loan constructs have purported to share collateral among multiple credit agreements (“collateral sharing arrangements”). Rather than rely on a subordination distribution system, in which a first lien holder is paid in full before a second lien holder receives any proceeds from the sale of a collateral asset, many of these collateral sharing arrangements specify that each participating lender is assigned a predetermined percentage share in each collateral asset. However, rather than allowing each securitization agreement and/or credit agreement to individually specify the collateral eligibility criteria, these collateral sharing arrangements may define universal collateral eligibility requirements that apply equally to all participating lenders. For example, two lending entities may agree to share equally in particular collateral provided that the identified collateral retains at least a minimum defined credit rating. If the identified collateral later becomes ineligible under the terms of the particular collateral sharing arrangement, the lender parties must either agree to amend the terms of the arrangement, agree to grant a mutually acceptable exception, or otherwise call the loans secured by the collateral sharing arrangement.

Similarly, parties have historically utilized participation agreements by which multiple creditors can share interests in collateral related to a particular credit agreement. Various participation agreements allow lending institutions to share in risks and collateral interests on a pari passu basis. However, like a traditional collateral sharing arrangement, participation agreements generally define collateral eligibility and regulatory equity criteria that apply to all lending institutions associated with the agreement. Thus, in the event that a particular collateral instrument becomes ineligible under the terms of the participation agreement, all of the lending institutions must agree to grant an exception for an ineligible collateral agreement or to amend the collateral eligibility criteria, or the conduit lender, the securitization investor or the finance lender may be required to call the borrower loan secured by the ineligible collateral.

Therefore, a need exists for more flexible collateral substitution arrangements, collateral sharing arrangements, and participation agreements related to the issuance of ABS securities in order to provide more stability through the diversification in the marketplace for investors, equity holders, lenders and borrowers who participate in these types of transactions.

### BRIEF SUMMARY

Various embodiments are directed to a computer-implemented method for managing a database of collateral data to reflect one or more allocations of collateral among at least two lenders. In various embodiments, the method comprises steps for: receiving debt product data for a plurality of debt products in a non-transitory memory, wherein the debt product data defines database management criteria for linking data stored in a database and wherein the database management criteria comprises: data defining terms for sharing at least one collateral instrument among the plurality of debt products according to an initial allocation, the initial allocation defining an initial interest in at least a portion of the at least one collateral instrument in favor of at least a portion of the plurality of debt products; and data defining allocation rules for each of the plurality of debt products, wherein the allocation rules define acceptable characteristics of collateral instruments; receiving collateral data for one or more collateral instruments, wherein each of the one or more collateral instruments comprises a financial instrument under which an obligor agrees to make payments to satisfy a debt, and the financial instrument is secured by underlying collateral and the collateral data comprise characteristics of each of the one or more collateral instruments; storing, via at least one computer processor, the collateral data in the database; linking, via the at least one computer processor and based on the database management criteria, collateral data corresponding to the one or more collateral instruments with debt product data corresponding to one or more debt products for which the one or more collateral instruments satisfy corresponding allocation rules; wherein data identifying the links between the collateral data and the debt product data are stored in the database and reflect an initial allocation of collateral instruments among the plurality of debt products; and generating, via the at least one computer processor, allocation data based on the determined initial allocation, wherein the allocation data is indicative of links between collateral data associated with each of the one or more collateral instruments and debt product data associated with at least a portion of the debt products.

In various embodiments, the allocation data further defines collateral instrument interests for each debt product, the collateral instrument interests each define an interest level having a given value in at least one of the one or more collateral instruments to be utilized as collateral for the debt product. Moreover, various methods additionally comprise steps for generating, via the at least one computer processor, at least one notification to be sent to at least one party based at least in part on the allocation data, the at least one notification comprising data regarding the collateral associated with at least one debt product. Moreover, various embodiments comprise steps for receiving updated collateral data for the one or more collateral instruments, wherein the updated collateral data comprise updated characteristics for each of the one or more collateral instruments; updating, via the at least one computer processor, the collateral data to reflect the updated characteristics for each of the one or more collateral instruments; updating, via the at least one computer processor and based at least in part on the database management criteria and the updated collateral data, the links between the collateral data corresponding to the one or more collateral instruments with debt product data corresponding to one or more debt products for which the one or more collateral instruments satisfy corresponding allocation rules; wherein data identifying the updated links between the collateral data and the debt product data are stored in the database and reflect an updated allocation of collateral instruments among the plurality of debt products; and generating, via the at least one computer processor, updated allocation data based on the updated allocation, wherein the updated allocation data is indicative of links between collateral data associated with each of the one or more collateral instruments and debt product data associated with at least a portion of the debt products.

Moreover, in various embodiments, at least one of the plurality of debt products is selected from the group consisting of: (1) a credit facility and (2) a securitization structure, under the securitization structure the collateral instrument interest is used to secure an asset backed security, and a plurality of noteholders each have an interest in the asset backed security under which the plurality of noteholders receive at least a portion of payments collected under the terms of at least one collateral instrument associated with the collateral instrument interest.

Certain embodiments additionally comprise steps for: receiving, in the non-transitory memory, additional debt product data for at least one additional debt product, wherein the additional debt product data defines additional database management criteria for linking data stored in the database, and wherein the additional database management criteria comprises: data defining terms for sharing the one or more collateral instruments with the plurality of debt products according to an updated allocation, the updated allocation defining a new interest in at least a portion of the at least one collateral instrument in favor of at least a portion of the plurality of debt products; data defining additional allocation rules for the at least one additional debt product, wherein the additional allocation rules define acceptable characteristics of collateral instruments; updating, via the at least one computer processor and based at least in part on the database management criteria and the additional debt product data, the links between the collateral data corresponding to the one or more collateral instruments with debt product data corresponding to one or more debt products for which the one or more collateral instruments satisfy corresponding allocation rules; wherein data identifying the updated links between the collateral data and the debt product data are stored in the database and reflect an updated allocation of collateral instruments among the plurality of debt products; and generating, via the at least one computer processor, updated allocation data based on the determined updated allocation, wherein the updated allocation data is indicative of links between collateral data associated with each of the one or more collateral instruments and debt product data associated with at least a portion of the debt products.

In various embodiments, the characteristics for each of the one or more collateral instruments comprise at least one of: a credit rating, a geographic location of underlying collateral; an obligor identity; a collateral type, and an insurance carrier associated with the underlying collateral. Moreover, the debt product data may further comprise collateralization requirements for each of the plurality of debt products, the collateralization requirements defining an aggregate collateral value that must be associated with the debt product. In such embodiments, the method may further comprise steps for: determining, via the at least one computer processor, whether a debt product is under-collateralized based on the collateralization requirements of each debt product and the allocation data; and generating, via the at least one computer processor, an alert in response to a determination that at least one of the plurality of debt products is under-collateralized.

In various the debt product data may further comprise collateralization requirements for each of the plurality of debt products, the collateralization requirements defining an aggregate collateral value that must be associated with the debt product. In such embodiments, the method may further comprise steps for: determining, via the at least one computer processor, whether a debt product complies with applicable regulatory requirements that may be embodied as a calculations, measurements, standards and monitoring of such data to determine lender capital requirements, borrower equity requirements, liquidity buffers and the like; and generating, via the at least one computer processor, an alert in response to a determination that at least one of the plurality of debt products does not satisfy one or more regulatory requirements.

In various embodiments the method further comprises steps for determining, via the at least one computer processor, whether each collateral instrument is fully allocated among the plurality of debt products; and generating, via the at least one computer processor, an alert in response to a determination that at least one collateral instrument is not fully allocated among the plurality of debt products. In certain embodiments, the method additionally comprises steps for generating, via the at least one computer processor, one or more repurchase options under which a party may agree to purchase the interest in at least one collateral instrument that is not fully allocated among the plurality of debt products.

Various embodiments comprise steps for determining, via the at least one computer processor, whether the obligor has defaulted under terms of a collateral instrument and the underlying collateral associated with the financial instrument has been liquidated; in the event that the underlying collateral associated with the collateral instrument has been liquidated, determining, via the at least one computer processor, based at least in part on the allocation data, a distribution by which to distribute at least a portion of the proceeds collected as a result of the liquidation, wherein the distribution is determined based at least in part upon a verification that all of the allocation rules are satisfied; and via the at least one computer processor, causing at least a portion of the proceeds collected as a result of the liquidation to be distributed based at least in part on the distribution.

Certain embodiments are directed to a system for allocating collateral associated with one or more debt products among a plurality of lenders. The system may comprise one or more memory storage areas and one or more computer processors. In various embodiments, the one or more computer processors are configured to: receive debt product data for a plurality of debt products, wherein the debt product data defines database management criteria for linking data stored in a database and wherein the database management criteria comprises: data defining terms for sharing at least one collateral instrument among the plurality of debt products according to an initial allocation, the initial allocation defining an initial interest in at least a portion of the at least one collateral instrument in favor of at least a portion of the plurality of debt products; and data defining allocation rules for each of the plurality of debt products, wherein the allocation rules define acceptable characteristics of collateral instruments; receive collateral data for the one or more collateral instruments, wherein each of the one or more collateral instruments comprises a financial instrument under which an obligor agrees to make payments to satisfy a debt, and the financial instrument is secured by underlying collateral, and the collateral data comprise characteristics of each of the one or more collateral instruments; store the collateral data in the database; link, based on the database management criteria, collateral data corresponding to the one or more collateral instruments with debt product data corresponding to one or more debt products for which the one or more collateral instruments satisfy corresponding allocation rules; wherein data identifying the links between the collateral data and the debt product data are stored in the database and reflect an initial allocation of collateral instruments among the plurality of debt products; and generate allocation data based on the determined initial allocation, wherein the allocation data is indicative of links between collateral data associated with each of the one or more collateral instruments and debt product data associated with at least a portion of the debt products.

In various embodiments, the allocation data may further define collateral instrument interests for each debt product, the collateral instrument interests each define an interest level having a given value in at least one of the one or more collateral instruments to be utilized as collateral for the debt product. Moreover, the one or more computer processors may be further configured to generate at least one notification to be sent to at least one party based at least in part on the allocation data, the at least one notification comprising data regarding the collateral associated with at least one debt product.

In various embodiments, the one or more computer processors may be further configured to receive updated collateral data for the one or more collateral instruments, wherein the updated collateral data comprises updated characteristics for each of the one or more collateral instruments; and update the collateral data to reflect the updated characteristics for each of the one or more collateral instruments; update, based at least in part on the database management criteria and the updated collateral data, the links between the collateral data corresponding to the one or more collateral instruments with debt product data corresponding to one or more debt products for which the one or more collateral instruments satisfy corresponding allocation rules; wherein data identifying the updated links between the collateral data and the debt product data are stored in the database and reflect an updated allocation of collateral instruments among the plurality of debt products; and generate updated allocation data based on the updated allocation, wherein the updated allocation data is indicative of links between collateral data associated with each of the one or more collateral instruments and debt product data associated with at least a portion of the debt products.

In various embodiments, at least one of the plurality of debt products is selected from the group consisting of: (1) a credit facility and (2) a securitization structure, under the securitization structure the collateral instrument interest is used to secure an asset backed security, and a plurality of noteholders each have an interest in the asset backed security under which the plurality of noteholders receive at least a portion of payments collected under the terms of at least one collateral instrument associated with the collateral instrument interest. Moreover, in various embodiments, the one or more computer processors may be further configured to receive additional debt product data for at least one additional debt product, wherein the additional debt product data defines additional database management criteria for linking data stored in the database, and wherein the additional database management criteria comprises: data defining terms for sharing the one or more collateral instruments with the plurality of debt products according to a new allocation, the new allocation defining a new interest in at least a portion of the at least one collateral instrument in favor of at least a portion of the plurality of debt products; data defining additional allocation rules for the at least one additional debt product wherein the additional allocation rules define acceptable characteristics of collateral instruments; update, based at least in part on the database management criteria and the additional debt product data, the links between the collateral data corresponding to the one or more collateral instruments with debt product data corresponding to one or more debt products for which the one or more collateral instruments satisfy corresponding allocation rules; wherein data identifying the updated links between the collateral data and the debt product data are stored in the database and reflect an updated allocation of collateral instruments among the plurality of debt products; and generate updated allocation data based on the determined updated allocation, wherein the new allocation data is indicative of links between collateral data associated with each of the one or more collateral instruments and debt product data associated with at least a portion of the debt products.

In various embodiments, the characteristics for each of the one or more collateral instruments may comprise at least one of: a credit rating, a geographic location of underlying collateral; an obligor identity; a collateral type, and an insurance carrier associated with the underlying collateral.

In various embodiments, the debt product data may further comprise collateralization requirements for each of the plurality of debt products, the collateralization requirements defining an aggregate collateral value that must be associated with the debt product. In such embodiments, the one or more computer processors may be further configured to determine whether a debt product is under-collateralized based on the collateralization requirements of each debt product and the allocation data; and generate an alert in response to a determination that at least one of the plurality of debt products is under-collateralized.

In various embodiments, the one or more computer processors may be further configured to: determine whether each collateral instrument is fully allocated among the plurality of debt products; and generate an alert in response to a determination that at least one collateral instrument is not fully allocated among the plurality of debt products.

In various embodiments, the one or more computer processors are further configured to generate one or more repurchase options under which a party may agree to purchase the interest in at least one collateral instrument that is not fully allocated among the plurality of debt products. Moreover, in certain embodiments, the one or more computer processors may be further configured to determine whether the obligor has defaulted under terms of a collateral instrument and the underlying collateral associated with the financial instrument has been liquidated; in the event that the underlying collateral associated with the collateral instrument has been liquidated, determine, based at least in part on the allocation data, a distribution by which to distribute at least a portion of the proceeds collected as a result of the liquidation, wherein the distribution is determined based at least in part upon a verification that all of the allocation rules are satisfied; and causing at least a portion of the proceeds collected as a result of the liquidation to be distributed based at least in part on the distribution.

Various embodiments are directed to a non-transitory computer program product comprising at least one computer-readable storage medium having computer-readable program code portions embodied therein. In various embodiments, the computer-readable program code portions comprise an executable portion configured for receiving debt product data for a plurality of debt products, wherein the debt product data defines database management criteria for linking data stored in a database and wherein the database management criteria comprises: data defining for sharing one or more collateral instrument among the plurality of debt products according to an initial allocation, the initial allocation defining an initial interest in at least a portion of the at least one collateral instrument in favor of at least a portion of the plurality of debt products; and data defining allocation rules for each of the plurality of debt products, wherein the allocation rules define acceptable characteristics of collateral instruments; receiving collateral data for one or more collateral instruments, wherein each of the one or more collateral instruments comprises a financial instrument under which an obligor agrees to make payments to satisfy a debt, and the financial instrument is secured by underlying collateral and the collateral data comprise characteristics of each of the one or more collateral instruments; storing, via at least one computer processor, the collateral data in the database; linking, via the at least one computer processor and based on the database management criteria, collateral data corresponding to the one or more collateral instruments with debt product data corresponding to one or more debt products for which the one or more collateral instruments satisfy corresponding allocation rules; wherein data identifying the links between the collateral data and the debt product data are stored in the database and reflect an initial allocation of collateral instruments among the plurality of debt products; and generating allocation data based on the determined initial allocation, wherein the allocation data is indicative of links between collateral data associated with each of the one or more collateral instruments and debt product data associated with at least a portion of the debt products.

Moreover, various embodiments are directed to a computer implemented method for allocating payments collected under the terms of a financial instrument. In various embodiments, the method comprises steps for: receiving, in a non-transitory memory, payment data indicating a payment has been received from at least one obligor under the terms of at least one financial instrument, wherein the financial instrument is secured by at least one piece of underlying collateral; receiving, in the non-transitory memory, allocation data, wherein the allocation data define a collateral allocation by which payments received from the obligor are to be distributed among at least a portion of a plurality of parties each associated with at least one debt product and the allocation data is generated based on: debt product data for a plurality of debt products, each debt product comprising terms by which parties associated with each of the plurality of debt products agree to share collateral according to the collateral allocation, wherein the debt product data comprise allocation rules for each of the plurality of debt products, wherein the allocation rules are defined by the parties associated with each of the plurality of debt products, and define acceptable characteristics of collateral instruments; collateral data for the one or more financial instruments, wherein the collateral data comprise characteristics for each of the one or more financial instruments; and the results of a comparison between the collateral data for the one or more collateral instruments and the debt product data; and via the at least one computer processor, causing at least a portion of the payments received from the at least one obligor to be distributed to at least a portion of the plurality of parties.

Moreover, in various embodiments, the method may further comprise steps for receiving prepayment data indicating that an obligor has prepaid at least a portion of a debt owed under the terms of at least one financial instrument and a prepayment has been received; and via the at least one computer processor, causing at least a portion of the prepayment to be distributed to at least a portion of the plurality of parties.

Various embodiments further comprise steps for receiving liquidation data indicating that at least a portion of the underlying collateral securing a financial instrument has been liquidated and a liquidation payment has been received as a result of the liquidation; and via the at least one computer processor, causing at least a portion of the liquidation payment to be distributed to at least a portion of the plurality of parties.

Various embodiments are directed to a system for allocating payments collected under the terms of a financial instrument. In various embodiments, the system comprises one or more memory storage areas; and one or more computer processors. In various embodiments, the one or more computer processors may be configured to: receive payment data indicating a payment has been received from at least one obligor under the terms of at least one financial instrument, wherein the financial instrument is secured by at least one piece of underlying collateral; receive allocation data, wherein the allocation data define a collateral allocation by which payments received from the obligor are to be distributed among at least a portion of a plurality of parties each associated with at least one debt product and the allocation data is generated based on: debt product data for a plurality of debt products, each debt product comprising terms by which parties associated with each of the plurality of debt products agree to share collateral according to the collateral allocation, wherein the debt product data comprise allocation rules for each of the plurality of debt products, wherein the allocation rules are defined by the parties associated with each of the plurality of debt products, and define acceptable characteristics of collateral instruments; collateral data for the one or more financial instruments, wherein the collateral data comprise characteristics for each of the one or more financial instruments; and the results of a comparison between the collateral data for the one or more collateral instruments and the debt product data; and cause at least a portion of the payments received from the at least one obligor to be distributed to at least a portion of the plurality of parties.

In various embodiments, the one or more computer processors are configured to receive prepayment data indicating that an obligor has prepaid at least a portion of a debt owed under the terms of at least one financial instrument and a prepayment has been received; and cause at least a portion of the prepayment data to be distributed to at least a portion of the plurality of parties.

In various embodiments, the one or more computer processors are further configured to: receive liquidation data indicating that at least a portion of the underlying collateral securing a financial instrument has been liquidated and a liquidation payment has been received as a result of the liquidation; and cause at least a portion of the liquidation payment to be distributed to at least a portion of the plurality of parties.

Various embodiments are directed to a non-transitory computer program product comprising at least one computer-readable storage medium having computer-readable program code portions embodied therein, the computer-readable program code portions comprising: an executable portion configured for receiving payment data indicating a payment has been received from at least one obligor under the terms of at least one financial instrument, wherein the financial instrument is secured by at least one piece of underlying collateral; an executable portion configured for receiving allocation data, wherein the allocation data define a collateral allocation by which payments received from the obligor are to be distributed among at least a portion of a plurality of parties each associated with at least one debt product and the allocation data is generated based on: debt product data for a plurality of debt products, each debt product comprising terms by which parties associated with each of the plurality of debt products agree to share collateral according to the collateral allocation, wherein the debt product data comprise allocation rules for each of the plurality of debt products, the allocation rules defining acceptable characteristics of collateral; collateral data for the one or more financial instruments, wherein the collateral data comprise characteristics for each of the one or more financial instruments; and the results of a comparison between the collateral data for the one or more collateral instruments and the debt product data; and an executable portion configured for causing at least a portion of the payments received from the at least one obligor to be distributed to at least a portion of the plurality of parties.

### BRIEF DESCRIPTION OF THE SEVERAL VIEWS OF THE DRAWINGS

Reference will now be made to the accompanying drawings, which are not necessarily drawn to scale, and wherein:

FIG. 1A illustrates exemplary relationships between parties involved in a securitization process;

FIG. 1B illustrates exemplary relationships between parties involved in a credit facility agreement;

FIG. 2 is a schematic diagram of a computer system according to various embodiments of the present invention;

FIG. 3 is a schematic diagram of a computer system according to various embodiments of the present invention;

FIG. 4A is a schematic diagram of a server according to various embodiments of the present invention;

FIG. 4B is a schematic diagram of a distributed handheld device according to various embodiments of the present invention;

FIG. 5 illustrates exemplary relationships between parties involved in a collateral sharing agreement according to various embodiments of the present invention;

FIG. 6 illustrates an exemplary granularity calculation according to various embodiments of the present invention;

FIG. 7 illustrates exemplary steps carried out in the creation of a credit facility according to various embodiments of the present invention;

FIG. 8 illustrates exemplary steps carried out in the creation of an asset backed security according to various embodiments of the present invention;

FIG. 9 illustrates exemplary relationships among a plurality of debt products each having an interest in a collateral account according to various embodiments of the present invention;

FIG. 10 illustrates the exemplary relationships among various modules present in various embodiments of the present invention;

FIG. 11 illustrates exemplary steps carried out by a collateral agent according to various embodiments of the present invention; and

FIG. 12 illustrates exemplary steps carried out by a servicer according to various embodiments of the present invention.

### DETAILED DESCRIPTION

The present invention will now be described more fully hereinafter with reference to the accompanying drawings, in which some, but not all embodiments of the invention are shown. Indeed, the invention may be embodied in many different forms and should not be construed as limited to the embodiments set forth herein. Rather, these embodiments are provided so that this disclosure will satisfy applicable legal requirements. Like numbers refer to like elements throughout.

Overview

When creating and selling asset backed securities and credit agreements (collectively referred to herein as “debt products”), the collateral utilized to secure these debt products is often defined in terms of the securitization or credit agreement and thus cannot be changed or substituted over the life of the debt product. In conventional arrangements, where an originator grants a line of credit to an obligor and an advance to the obligor under the terms of the line of credit, that advance is secured by a pledged asset as collateral. If additional advances are granted to the obligor under the terms of the line of credit, each advance may be secured by the same pledged asset or different described collateral. However, if each of these advances and all rights to collect payments under the terms of the advances are sold to a third party as debt products, the third party (or any subsequent purchasers or interest holders) cannot shift the collateral securing each advance in order to create a more attractive debt product. For example, in the case where the underlying collateral under which an obligor agrees to make periodic payments to repay a debt changes credit rating, the owner of the debt product is unable to substitute additional collateral.

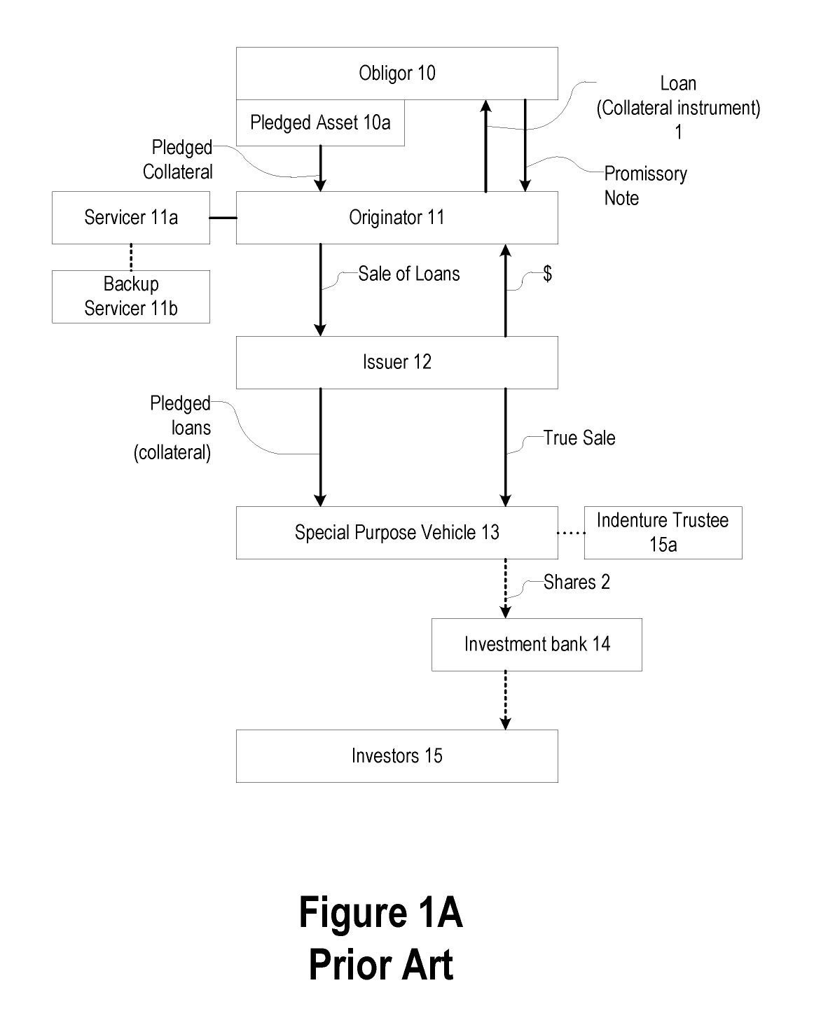

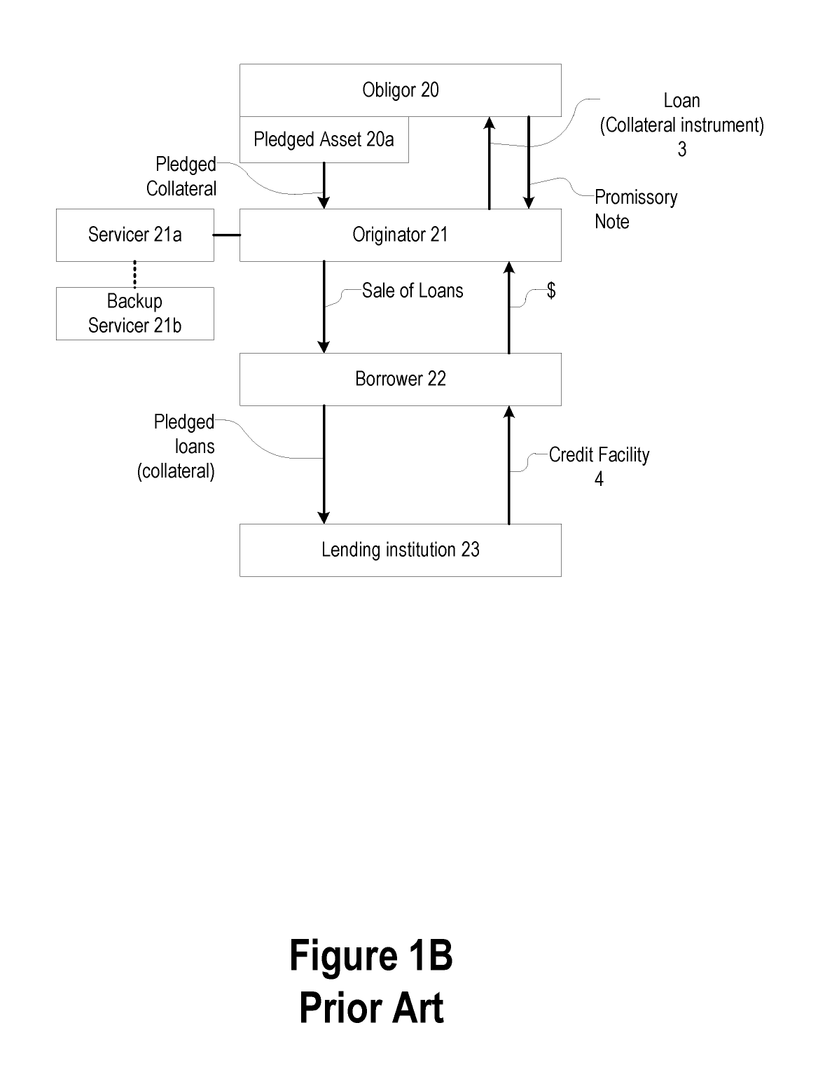

Exemplary procedures for creating a debt product and subsequently creating asset backed securities utilizing the debt products, or utilizing the debt product as collateral to facilitate a credit facility, are illustrated in FIGS. 1A and 1B. As shown in FIGS. 1A and 1B, under conventional arrangements the underlying collateral securing a debt product necessarily remains associated with the debt product throughout the life of the debt product. In the event the collateral becomes ineligible under terms of a particular securitization or credit agreement, the lending institution or entity overseeing the securitization collateral is typically required to call the loan and potentially end the securitization or credit agreement prematurely. While in the case of a credit agreement, the lending institution may have the opportunity to amend the collateral requirements or to grant an exception for the collateral, the terms included in a securitization agreement generally cannot be changed. As a result, an indenture trustee or other entity representing the interests of the noteholders is typically required to call the loans underlying the security, regardless of any additional factors that may otherwise influence the noteholders' decision to grant an exception or amend the terms of the securitization. In many cases this inflexibility is undesirable and contrary to the wishes or instructions of the involved parties, who may be willing to substitute alternative collateral agreements that satisfy all the eligibility requirements of the securitization agreement or credit agreement. However, because the contractual terms of the securitization or credit agreement cannot be easily modified, this result is typically unavoidable due to the difficulties involved in amending these credit agreements. Accordingly, described herein is a diversification mechanism for the marketplace embodied in the presented systems and methods as a custodial, collateral agency, servicing and intercreditor agreement (CCASIA), as set forth herein.

Referring again to FIG. 1A, which illustrates a system historically utilized in various securitization processes, loans granted by an originator 11 in favor of an obligor 10 may be utilized to create asset backed securities. As will be understood by those skilled in the art, the obligor 10 may agree to pay a servicer 11a (or backup servicer 11b), who may then distribute the payment to the appropriate party. For example, one or more commercial loans, multiple home loans, multiple vehicle loans, and/or the like may be aggregated into a block of loans and sold to an issuer 12. The issuer 12 may subsequently sell the aggregated block of loans to a special purpose vehicle (SPV) 13 (e.g., a trust) via a “true sale” procedure, in which the issuer retains no ownership interest in the sold loans. In certain instances, the aggregated loans may be organized into one or more tranches of similar loans. For example, each tranche may include all of the loans of a given credit quality. In certain instances, one or more credit enhancements may be applied to at least a portion of the aggregated loans, so as to increase the collective credit quality of the aggregated loans. Exemplary systems and methods for generating credit enhancements have been described in at least U.S. Pat. No. 7,797,214 to Rosen et al., which is incorporated herein in its entirety. The issuer 12 or other entity overseeing the creation of the asset backed securities may then generate shares 2 to be sold through an investment bank 14 or similar entity to investors 15. Once the securities are created, the collateral securing these securities cannot be substituted or replaced by other collateral, and therefore the securities may be subject to a risk of prematurely calling the loans underlying the securitization in the event the loans fail to meet the collateral requirements set forth in the securitization agreement and/or fail to meet applicable equity requirements under applicable banking regulations such as Basel III, Dodd-Frank Wall Street Reform and Consumer Protection Act, and the like. In various embodiments, the securitization structure may appoint an indenture trustee 15a to represent the interests of the investors 15.

Similarly, as shown in FIG. 1B, which illustrates an additional prior art system historically utilized in various loan arrangements, the rights associated with loans granted by an originator 21 in favor of one or more obligors 20 may be sold to a third party (e.g., a borrower 22), who can then utilize these loans as collateral for credit facility agreements 4 with lending institutions. As will be understood by those skilled in the art, the obligor 20 may agree to pay a servicer 21a (or backup servicer 21b), who may then distribute the payment to the appropriate party. For example, one or more commercial loans, multiple home loans, multiple vehicle loans, and/or the like may be aggregated into a block of loans and sold to a borrower 22. The borrower 22 may subsequently obtain a credit facility 4 (e.g., a line of credit, revolving credit, and/or the like) from a lending institution 23 and utilize the purchased loans to secure the various advances made under the terms of the credit facility. In these agreements, the lending institution 23 may institute certain requirements of the underlying loans, such as minimum credit ratings, loan types, and/or the like. However, once a particular credit facility agreement has been signed, the specified collateral securing the credit facility 4 cannot be changed. Historically, the lending institution 23 assumes a risk that the underlying loans will remain eligible under the terms of the credit facility agreement, and the borrower 22 assumes the risk that the lending institution 23 may recall outstanding loans in the event that at least a portion of the underlying security becomes ineligible under the terms of the credit facility agreement.

Although historically the collateral must be specified in the terms of the securitization agreement or credit agreement, some historical loan constructs have purported to share collateral among multiple securitization agreements and/or credit agreements. Rather than rely on a subordination distribution system under which a first lien holder is paid in full before a second lien holder receives any proceeds from the sale of a collateral asset, many of these collateral sharing arrangements specify that each participating securitization agreement and/or credit agreement is assigned a predetermined percentage share in each collateral instrument. However, rather than allowing each credit agreement and/or securitization agreement to individually specify collateral eligibility criteria, these collateral sharing arrangements define universal collateral eligibility requirements that apply equally to all participating securitization agreements and/or credit agreements. For example, two entities may agree to share equally in a particular collateral agreement provided that the identified collateral agreement retains at least a minimum defined credit rating. If the identified collateral agreement later becomes ineligible under the terms of the agreement, the parties must agree to amend the terms of the agreement, must agree to grant an exception, or must call the loans secured by the collateral agreement.

Similarly, parties have historically utilized participation agreements by which to share interests in collateral related to a particular credit agreement. Various participation agreements allow lending institutions to share in risks and collateral interests on a pari passu basis. However, like a traditional collateral sharing arrangement, participation agreements generally define collateral eligibility criteria that apply to all lending institutions associated with the agreement. Thus, in the event that a particular collateral instrument becomes ineligible under the terms of the participation agreement, all of the lending institutions must agree to grant an exception for an ineligible collateral agreement or to amend the collateral eligibility criteria, or the lead bank must call the loan secured by the ineligible collateral.

Various embodiments of the present invention are directed to systems and methods for sharing collateral among multiple debt products. For example, various embodiments provide systems and methods for organizing a database containing data reflective of a flexible allocation of collateral among a plurality of debt products. Various embodiments facilitate lending institutions to share collateral according to a pari passu allocation, under which the parties associated with a credit sharing agreement according to an embodiment of the present invention are not subordinated to one another, and instead any proceeds and/or distributions occurring as a result of the collateral instrument may be distributed to each of the interested parties according to their pro rata interest. As a non-limiting example, if a party has a 25% interest in a particular collateral instrument, the party will receive 25% of any proceeds and/or distributions arising from the collateral instrument.

Typically, debt products utilize one or more finance instruments as a collateral instrument for the debt product. For example, a borrower may have rights to obtain periodic payments made by an obligor under the terms of one or more advances due under a financial instrument (e.g., a line of credit). The borrower may utilize at least a portion of the rights to collect these periodic payments as a collateral instrument for a credit facility granted by a lending institution. In a conventional collateral sharing agreement as is well known and understood in the art, multiple lending institutions (or a single lending institution granting loans under multiple credit agreements) may agree to share the collateral according to preset terms. As a non-limiting example, a first lending institution may agree to hold a 75% interest in a given collateral instrument while a second lending institution may agree to hold the remaining 25% interest in the identified collateral instrument. Due to pre-established, inflexible terms in such conventional sharing arrangements, both parties are required to agree on particular eligibility requirements of the collateral, such as a minimum credit rating and/or type of financial instrument to be utilized as collateral. If the collateral instrument later becomes ineligible, or fails to meet the collateral eligibility requirements specified under the collateral sharing arrangement, the lending institutions are, under such conventional arrangements, required to (1) renegotiate the terms of the collateral sharing arrangement in order to maintain the collateral, (2) require the borrower to post new or additional collateral, and/or (3) call the loan and split the proceeds according to the agreed sharing arrangement. Often times, these results are undesirable and contrary to the wishes of involved parties, who may be willing to substitute other collateral meeting the collateral eligibility requirements and thus maintain the loan under the existing terms.

To overcome the above-noted deficiencies and disadvantages of conventional arrangements, various embodiments of the present invention provide greater flexibility to lending institutions in sharing and maintaining collateral among multiple lending institutions. In contrast to the commonly utilized methods of specifically agreeing to split one or more identified collateral instrument between multiple lending institutions, under the novel and inventive configurations described herein, each party to the sharing arrangement may enter into a CCASIA, under which each lending institution, creditor, and/or securitization structure agrees take an interest in a collateral account as collateral to facilitate a debt product. In certain embodiments, each interested party's interest ensures that the associated debt product remains adequately collateralized, such that collateral having at least the value required for the debt product is associated with each debt product. Unlike conventional sharing arrangements, under the terms of the CCASIA, each interested party may maintain separate collateral eligibility requirements while sharing collateral among multiple debt products. Moreover, the described database management concepts ensure that an allocation of collateral among a plurality of debt products remains in constant compliance with applicable rules, regulations, laws, and/or debt product specific criteria (e.g., collateral eligibility requirements) regarding characteristics of collateral utilized to collateralize a particular debt product. As discussed herein, collateral qualities (e.g., ratings) may vary constantly and/or instantaneously, thereby requiring constant and/or instantaneous reallocation of collateral to ensure that debt products remain in constant compliance with applicable rules, regulations, laws, and/or debt product specific criteria.

In various embodiments, a system stores collateral data having information regarding characteristics of each collateral instrument and debt product data having information regarding the various collateral eligibility requirements associated with each debt product with an interest in the shared collateral. The collateral eligibility requirements define database management criteria for establishing, maintaining, and/or updating links between data (e.g., collateral data and/or debt product data) stored in the database. In certain embodiments, the system may compare the collateral characteristics and collateral instrument characteristic requirements in order to determine an optimal allocation of collateral among the various debt products such that each collateral eligibility requirement is satisfied by the allocation. The optimal allocation may be highly fluid and/or dynamic and reactive to changes in the collateral data and/or the debt product data to ensure the optimal allocation remains in constant compliance with rules, regulations, laws, and/or collateral eligibility requirements. Over time, the system may be configured to receive updated collateral data and/or updated debt product data from a variety of sources. Upon receipt thereof, according to various embodiments, the system may reallocate the collateral instruments among the various debt products such that each of the collateral eligibility requirements remain satisfied considering the updated data by relinking collateral data with debt product data. As a non-limiting example, following an initial allocation, a particular debt product may have partial interests in several collateral instruments. However, after the system receives updated collateral instrument characteristic data regarding the characteristics of each of the collateral instruments, the system may reallocate the various collateral instruments such that the debt product may receive new partial interests in several new collateral instruments. Therefore, as will be understood by those skilled in the art, in various embodiments a particular debt product need not be permanently associated with a particular collateral instrument, or limited to the one or more collateral instruments associated with the debt product after an initial allocation.

As will be described in greater detail herein, various embodiments account for circumstances in which each of the collateral eligibility requirements cannot be satisfied by providing an allocation of collateral instruments among a plurality of debt products. In such circumstances, according to various embodiments, the system may be configured to generate an alert to a user, who may then facilitate a buyout of a particular collateral instrument by one or more parties.

According to various embodiments, the system may also be configured to facilitate distributions of payments received from an obligor under the terms of a collateral instrument. As will be described in greater detail herein, payments received from an obligor may be directed into a common collateral account, and may be distributed to parties having at least a partial interest in the particular collateral instrument according to their pro rata shares.

Computer System

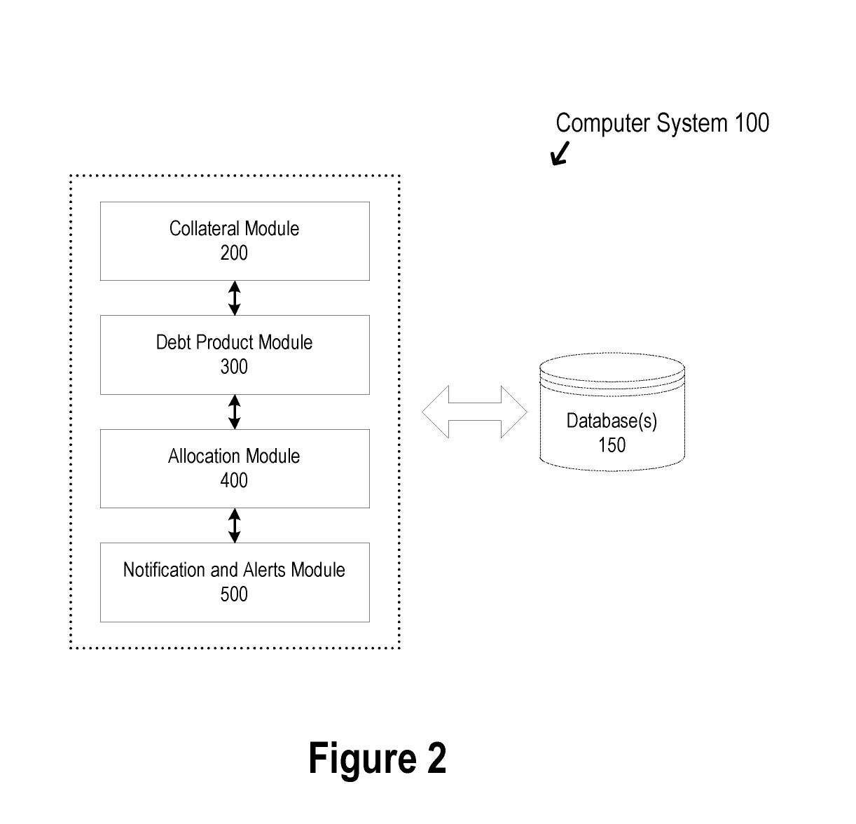

As illustrated generally in FIG. 2, various embodiments of the present invention include a computer system 100. Various embodiments may be implemented in a cloud-based computing network embodiment. The computer system 100 may include a plurality of interconnected modules, including, as a non-limiting example, a Collateral Module 200, a Debt Product Module 300, an Allocation Module 400, and a Notification and Alerts Module 500. As shown in FIG. 2, the various modules may include, incorporate, or access one or more databases or relational databases 150, and may also include a database management system, and an interface with query capabilities. The various modules may be located geographically remote from one another and may be in communication with one another via a network (e.g., the internet).

For FIG. 2 and other drawing figures illustrating computer modules, tables, tools, and/or the like, it should be noted that such diagrams are intended to provide order to the discussion and not for purposes of limitation. The modules in a computer system according to various embodiments of the present invention, for example, may be arranged in various orders, with different names, different connections, and may include any of a variety of software tools or routines designed to accomplish the functions described herein.

As will be described in greater detail herein, each of the modules included in the computer system 100 may be configured to receive data from external sources (e.g., credit rating agencies, lending institutions, borrowers, servicers, and/or the like). Each of the modules may additionally be configured to receive and transmit data to and from other modules included in the computer system 100. For example, the Collateral Module 200 may be configured to receive data regarding the current allocation of collateral among various debt products, as determined by the Allocation Module 400.

As will be described in greater detail herein, the computer system 100 may be embodied as an apparatus, computer program product, a computing entity, and/or a combination of computing entities. The computer system 100 may be configured to carry out one or more methods in order to complete the steps described herein.

Exemplary Apparatuses, Methods, Systems, Computer Program Products, & Computing Entities

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

Exemplary Architecture of System

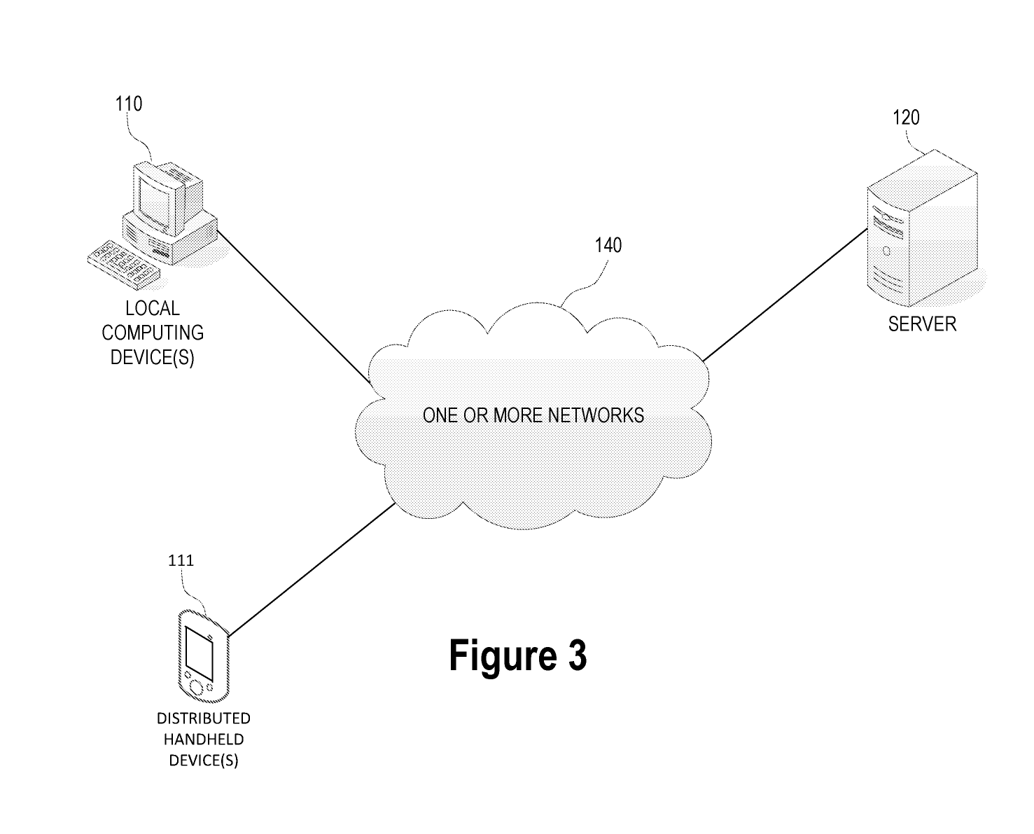

FIG. 3 is a block diagram of a system 100 that can be used in conjunction with various embodiments of the present invention. In at least the illustrated embodiment, the system 100 may include one or more local computing devices 110 and one or more distributed handheld or mobile devices 111 in communication with a central server 120 via one or more networks 140. Accordingly, various embodiments may be implemented via a cloud-based network structure. While FIG. 3 illustrates the various system entities as separate, standalone entities, the various embodiments are not limited to this particular architecture.

According to various embodiments of the present invention, the one or more networks 140 may be capable of supporting communication in accordance with any one or more of a number of second-generation (2G), 2.5G, third-generation (3G), and/or fourth-generation (4G) mobile communication protocols, or the like. More particularly, the one or more networks 140 may be capable of supporting communication in accordance with 2G wireless communication protocols IS-136 (TDMA), GSM, and IS-95 (CDMA). Also, for example, the one or more networks 140 may be capable of supporting communication in accordance with 2.5G wireless communication protocols GPRS, Enhanced Data GSM Environment (EDGE), or the like. In addition, for example, the one or more networks 140 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system may be configured to communicate with one another in accordance with techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

According to one embodiment, in addition to receiving data from the server 120, the local computing devices 110 may be further configured to collect and transmit data on their own. In various embodiments, the local computing devices 110 may be capable of receiving data via one or more input units or devices, such as a keypad, touchpad, or receiver. The local computing devices 110 may further be capable of storing data to one or more volatile or non-volatile memory modules, and outputting the data via one or more output units or devices, for example, by displaying data to the user operating the local computing device 110, or by transmitting data, for example over the one or more networks 140.

Exemplary Server

In various embodiments, the server 120 includes various systems for performing one or more functions in accordance with various embodiments of the present invention, including those more particularly shown and described herein. It should be understood, however, that the server 120 might include a variety of alternative devices for performing one or more like functions, without departing from the spirit and scope of the present invention. For example, at least a portion of the server 120, in certain embodiments, may be located on the local computing device 110 and/or the handheld or mobile device(s) 111, as may be desirable for particular applications. As will be described in further detail below, in at least one embodiment, the handheld or mobile device(s) 111 may contain one or more mobile applications 119 which may be configured so as to provide a user interface for communication with the server 120, all as will be likewise described in further detail below.

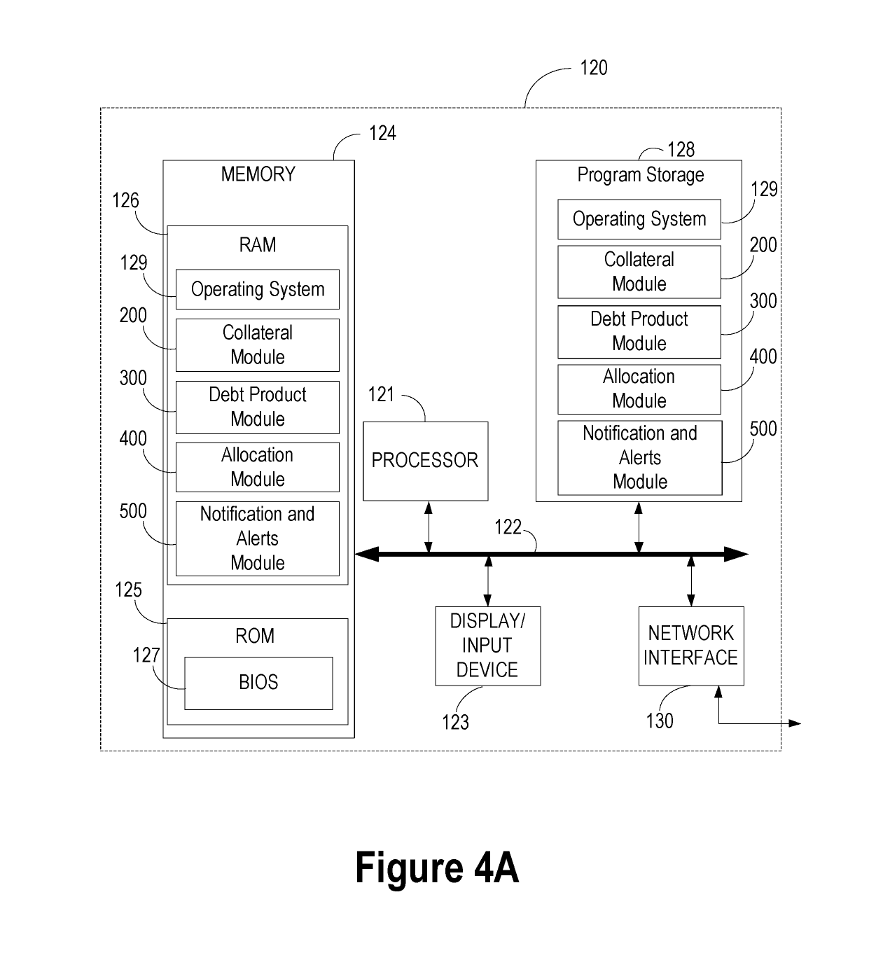

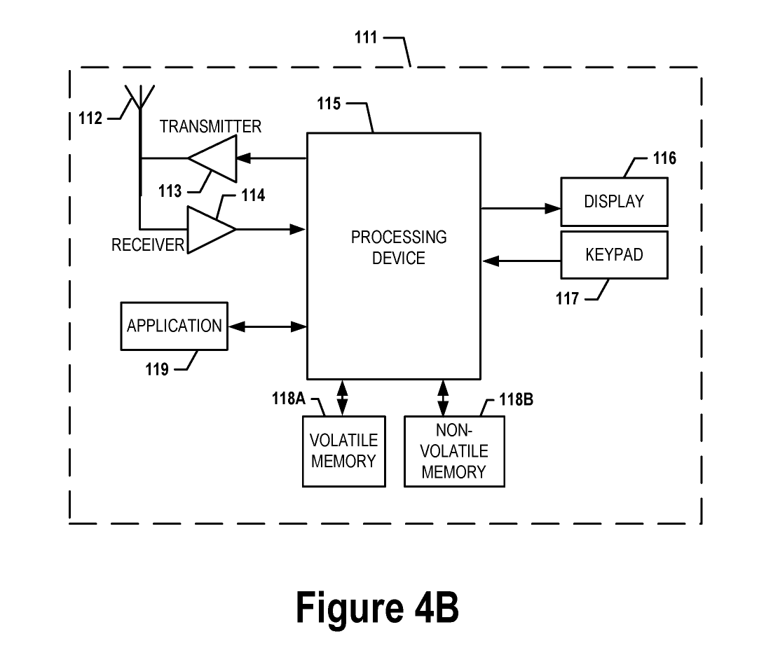

FIG. 4A is a schematic diagram of the server 120 according to various embodiments. The server 120 includes a processor 121 that communicates with other elements within the server via a system interface or bus 122. The server 120 may also include a display/input device 123 for receiving and displaying data. This display/input device 123 may be, for example, a keyboard or pointing device that is used in combination with a monitor. The server 120 further includes memory 124, which preferably includes both read only memory (ROM) 125 and random access memory (RAM) 126. The server's ROM 125 is used to store a basic input/output system 127 (BIOS), containing the basic routines that help to transfer information between elements within the server 120. Various ROM and RAM configurations have been previously described herein.

In addition, the server 120 includes at least one storage device or program storage 128, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 128 are connected to the system bus 122 by an appropriate interface. The storage devices 128 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 128 and/or memory of the server 120 may further provide the functions of a data storage device, which may store collateral instrument characteristic data, debt product data, allocation data, and/or the like that may be accessed by the server 120. In this regard, the storage device 120 may comprise one or more databases. The term “database” refers to a structured collection of records or data that is stored in a computer system, such as via a relational database, hierarchical database, or network database and as such, should not be construed in a limiting fashion.

A number of program modules comprising, for example, one or more computer-readable program code portions executable by the processor 121, may be stored by the various storage devices 128 and within RAM 126. Such program modules include an operating system 129, a Collateral Module 200, a Debt Product Module 300, an Allocation Module 400, and a Notification and Alert Module 500. In these and other embodiments, the various modules 200, 300, 400, and 500 control certain aspects of the operation of the server 120 with the assistance of the processor 121 and operating system 129. As illustrated in FIG. 2, such modules 200, 300, 400, and 500 may in various embodiments operate as individual components of the computer system 100, and may be in communication with one or more databases 150. In still other embodiments, it should be understood that one or more additional and/or alternative modules may also be provided, without departing from the scope and nature of the present invention.

In various embodiments, the program modules 200, 300, 400, and 500 are executed by the server 120 and are configured to generate one or more graphical user interfaces, reports, instructions, and/or notifications/alerts, all accessible and/or transmittable to various users of the system. In certain embodiments, the user interfaces, reports, instructions, and/or notifications/alerts may be accessible via one or more networks 140, which may include the Internet or other feasible communications network, as previously discussed. The operation and interaction of the program modules 200, 300, 400, and 500 is described in further detail elsewhere herein.

In various embodiments, it should also be understood that one or more of the modules 200, 300, 400, and 500 may be alternatively and/or additionally (e.g., in duplicate) stored locally on one or more local computing devices 110 and may be executed by one or more processors of the same. According to various embodiments, the modules 200, 300, 400, and 500 may send data to, receive data from, and utilize data contained in one or more databases 150 (see FIG. 2), which may be comprised of one or more separate, linked and/or networked databases.

Also located within the server 120 is a network interface 130 for interfacing and communicating with other elements of the one or more networks 140. It will be appreciated by one of ordinary skill in the art that one or more of the server 120 components may be located geographically remotely from other server components. Furthermore, one or more of the server 120 components may be combined, and/or additional components performing functions described herein may also be included in the server 120. As a non-limiting example, various server 120 components may comprise one or more modules 200, 300, 400, and/or 500 as illustrated in FIG. 2, and may thus comprise at least a portion of the computer system 100.

While the foregoing describes a single processor 121, as one of ordinary skill in the art will recognize, the server 120 may comprise multiple processors operating in conjunction with one another to perform the functionality described herein. In addition to the memory 124 and the processor 121 can also be connected to at least one interface or other means for displaying, transmitting, and/or receiving data, content, and/or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the entity to receive data from a user, such as a keypad, a touch display, a joystick or other input device.

Still further, while reference is made to the “server” 120, as one of ordinary skill in the art will recognize, embodiments of the present invention are not limited to traditionally defined server architectures. Still further, the system of embodiments of the present invention is not limited to a single server, or similar network entity or mainframe computer system (see e.g., FIG. 2). Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the server 120 may likewise be used without departing from the spirit and scope of embodiments of the present invention.

According to various embodiments, many individual steps of a process may or may not be carried out utilizing the computer systems and/or servers described herein, and the degree of computer implementation may vary, as may be desirable and/or beneficial for one or more particular applications.

Distributed Handheld (or Mobile) Device(s) 111

FIG. 2B provides an illustrative schematic representative of a mobile device 111 that can be used in conjunction with various embodiments of the present invention. Mobile devices 111 can be operated by various parties. As shown in FIG. 4B, a mobile device 111 may include an antenna 112, a transmitter 113 (e.g., radio), a receiver 114 (e.g., radio), and a processing element 115 that provides signals to and receives signals from the transmitter 113 and receiver 114, respectively.

The signals provided to and received from the transmitter 113 and the receiver 114, respectively, may include signaling data in accordance with an air interface standard of applicable wireless systems to communicate with various entities, such as the server 120, the local computing devices 110, and/or the like. In this regard, the mobile device 111 may be capable of operating with one or more air interface standards, communication protocols, modulation types, and access types. More particularly, the mobile device 111 may operate in accordance with any of a number of wireless communication standards and protocols. In a particular embodiment, the mobile device 111 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 111 may according to various embodiments communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The mobile device 111 can also download changes, add-ons, and updates, for instance, to its firmware, software (e.g., including executable instructions, applications, program modules), and operating system.

According to one embodiment, the mobile device 111 may include a location determining device and/or functionality. For example, the mobile device 111 may include a GPS module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile device 111 may also comprise a user interface (that can include a display 116 coupled to a processing element 115) and/or a user input interface (coupled to a processing element 115). The user input interface can comprise any of a number of devices allowing the mobile device 111 to receive data, such as a keypad 117 (hard or soft), a touch display, voice or motion interfaces, or other input device. In embodiments including a keypad 117, the keypad can include (or cause display of) the conventional numeric (0-9) and related keys (#, *), and other keys used for operating the mobile device 111 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 111 can also include volatile storage or memory 118A and/or non-volatile storage or memory 118B, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the mobile device 111.

The mobile device 11 may also include one or more mobile applications 119. The mobile application 119 may further provide a feature via which various tasks may be performed with the mobile device 111. Various configurations may be provided, as may be desirable for one or more users of the mobile device 111 and the system 100 as a whole.

Inter-Creditor Structure

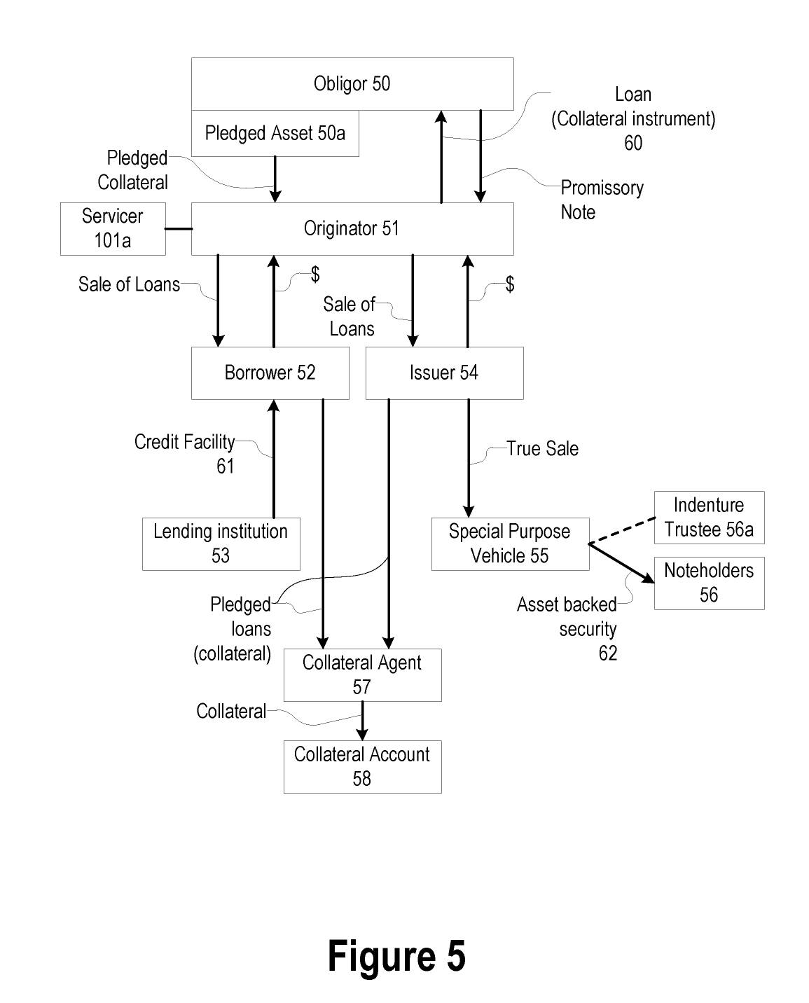

As illustrated in FIG. 5, various embodiments of the present invention may be utilized to facilitate transactions between multiple parties included in an inter-creditor collateral sharing agreement (e.g., the CCASIA). As described in greater detail herein, the CCASIA may facilitate the sharing of collateral instruments 60 among various debt products. Each of these collateral instruments 60 may comprise one or more agreements under which one or more obligors 50 agree to make payments to satisfy a debt. Each of these collateral instruments 60 may be secured by a promissory note and a pledged asset 50a (e.g., real property, personal property, intellectual property, and/or the like). In various embodiments, the collateral agreements may have been initially executed between an obligor 50 and an originator 51, such that the originator 51 agreed to grant a loan in favor of the obligor 50 in exchange for an agreement to repay the loan (e.g., a promissory note). In various embodiments, the obligor 50 may agree to make payments to a servicer 51a, who then distributes the payments to the appropriate parties. As will be understood by those skilled in the art, in various embodiments, the servicer 51a may be replaced by a backup servicer under appropriate circumstances that may be identified in the CCASIA.

As will be understood by those skilled in the art, the originator 51 may sell a single loan to a third party, such as a borrower 52 or issuer 54, or may aggregate a plurality of loans and sell the resulting bundle of loans to one or more third parties. Alternatively, the originator 51 may make multiple loan advances to the obligor 50 under the terms of the collateral instrument, and the originator may separately retain, sell, or finance each loan advance made under the collateral instrument 60.

Under the terms of a sale of a loan, an advance made under the terms of a loan 60, or a plurality of loans, from an originator 51 to a borrower 52 or issuer 54, the obligor 50 may continue to make payments to the servicer, who may then distribute or cause to be distributed the payments to the purchasing party (e.g., the issuer or borrower). The originator 51 may sell each loan individually, each advance made under the terms of a loan individually, or may aggregate and sell a bundle of loans (e.g., as a mortgage backed security) to one or more third parties.

Credit Agreements

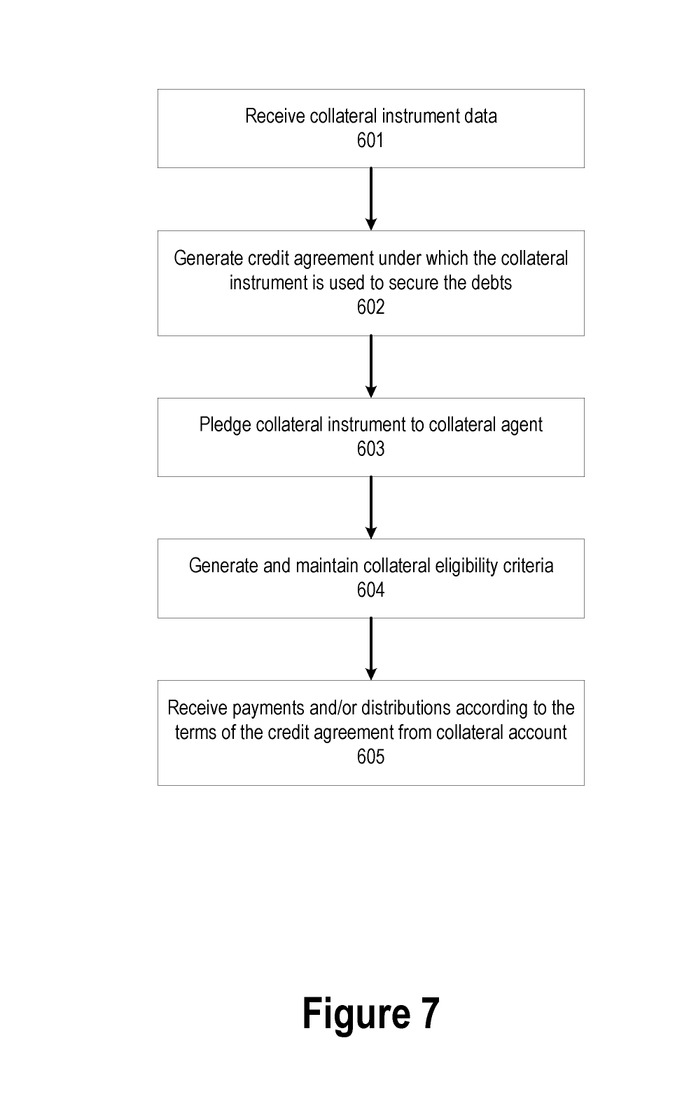

When selling to a borrower 52, as illustrated in FIG. 5, the borrower may then utilize the purchased loans as collateral to facilitate a credit facility 61 (or other credit agreement) entered into with a lending institution 53. FIG. 7 identifies various steps that may be involved in the creation of a credit facility 61 secured by a share in a collateral account 58, as described herein. As illustrated in FIG. 7, at step 601 at least one of the parties (e.g., the borrower 52 and/or the lending institution 53) associated with a prospective credit facility 61 may receive collateral instrument data comprising information regarding characteristics of a collateral instrument 60 to be added to a collateral account 58 in order to obtain a share in the collateral account 58 to be used to secure the credit facility 61. In various embodiments, the credit facility 61 generated at step 602 and entered into between the borrower 52 and the lending institution 53 may specify that the collateral is to be governed by the CCASIA as described herein. According to terms of the credit facility 61, the collateral may be pledged at step 603 to a collateral agent 57, who may deposit any documentation in a collateral account 58 and distribute (or cause to be distributed) any proceeds or distributions accordingly. In response to pledging the collateral to the collateral agent 57, the collateral agent may grant a share in the collateral account 58 as collateral to facilitate the debt product. The share in the collateral account may be defined with reference to the value of the pledged collateral, or it may be defined in terms of a total interest level in the collateral account 58. As a non-limiting example, if a party pledges collateral instruments with a value of $50 million to be deposited into the collateral account 58, the collateral agent 57 may grant the party a share in the collateral account 58 having a value of $50 million. As a second non-limiting example, if a party pledges collateral instruments generating $10,000 per month for 48 months to be deposited into the collateral account 58, the collateral agent 57 may grant the pledging party a share in the collateral account having the same earning potential. As yet another non-limiting example, if a party pledges collateral having a value of $50 million to be deposited in a collateral account 58, and consequently the value of the total collateral pledged to the collateral account equals $500 million after the newly pledged collateral is added, the collateral agent 57 may grant the pledging party a 10% interest in the collateral account.

As will be understood by those skilled in the art, the proceeds and/or distributions arising from the pledged collateral instrument 60 may be distributed in whole or in part directly to the lending institution 53 or borrower 52, who may subsequently make payments to the lending institution 53 under the terms of the credit facility 61. In various embodiments, the servicer 51a may distribute (or cause to be distributed) the proceeds and/or distributions arising from the collateral instrument 60 according to the terms of the credit facility 61.

With this context, as indicated at step 604 of FIG. 7, the credit facility 61 may specify one or more collateral allocation rules by which collateral pledged to the collateral agent 57 and deposited in the collateral account 58 may be shared among a plurality of debt products. As described in greater detail herein, these collateral allocation rules may specify one or more collateral eligibility requirements that must be satisfied for a particular collateral instrument 60 to be used to secure the credit facility 61. As non-limiting examples, the credit facility 61 may specify (1) a minimum and/or maximum credit rating for any collateral instrument to be used for collateral for the credit agreement (e.g., a Moody's rating of A2); (2) a minimum and/or maximum percentage interest in a single collateral instrument (e.g., the credit facility requires that no more than 5% of any one collateral instrument be used as a portion of the collateral for the credit facility); (3) a minimum and/or maximum percentage of underlying collateral that may be located in a particular region (e.g., no more than 5% of the total pledged assets 50a used to secure the collateral instruments 60 may consist of real property located in California); (4) a minimum and/or maximum percentage interest in collateral instruments 60 executed by a single obligor 50; and/or the like.

As described herein, the credit facilities 61 may comprise one or more of such collateral eligibility criteria and such criteria may refer to any of a plurality of collateral instrument characteristics. In various embodiments, the collateral agent 57 may compare the characteristics of each of a plurality of collateral instruments against the collateral eligibility criteria arising from the plurality of credit facilities 61 under which the parties (e.g., the borrower 52 and lending institution 53) agreed to share collateral. Based on the results of the comparison, the collateral agent 57 may determine an optimal allocation of collateral among the plurality of debt products.

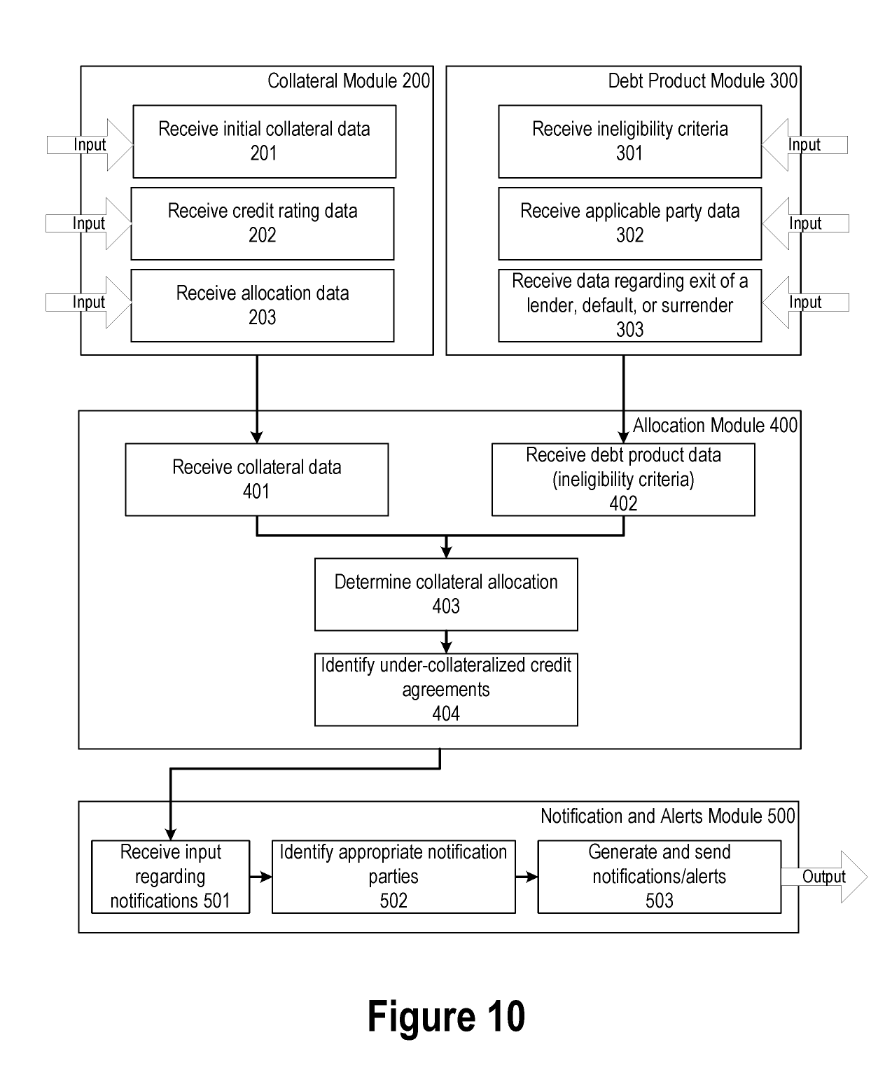

In various embodiments, the collateral allocation may result in each debt product being adequately collateralized, such that at least the minimum value of collateral is associated with each debt product in the CCASIA. However, in other embodiments the collateral allocation may result in at least one debt product being under-collateralized, such that the debt product is secured by collateral having a value less than the minimum value of collateral. For example, as illustrated at Block 404 of FIG. 10, the collateral allocation may be configured in certain embodiments, to determine if a particular debt product is under-collateralized, such that the value of the collateral is insufficient to secure the debt product. If the collateral allocation system determines that a particular debt product is under-collateralized, and a collateral allocation under which the debt product may be adequately collateralized is impossible in light of the various collateral eligibility requirements associated with the CCASIA, the collateral allocation system may be configured to generate an alert to one or more users (e.g., the borrower 52, the lending institution 53, and/or other parties) informing the user of such allocation conflicts.

As indicated herein and illustrated at step 605 of FIG. 7, at least one of the parties associated with the credit facility 61 (e.g., the borrower 52 and/or lending institution 53) may receive payments and/or distributions according to the terms of the credit facility 61. In various embodiments, these payments and/or distributions may have been initially generated from one or more collateral instruments 60 associated at least in part with the credit facility 61 under the terms of the determined collateral allocation.

Securitization

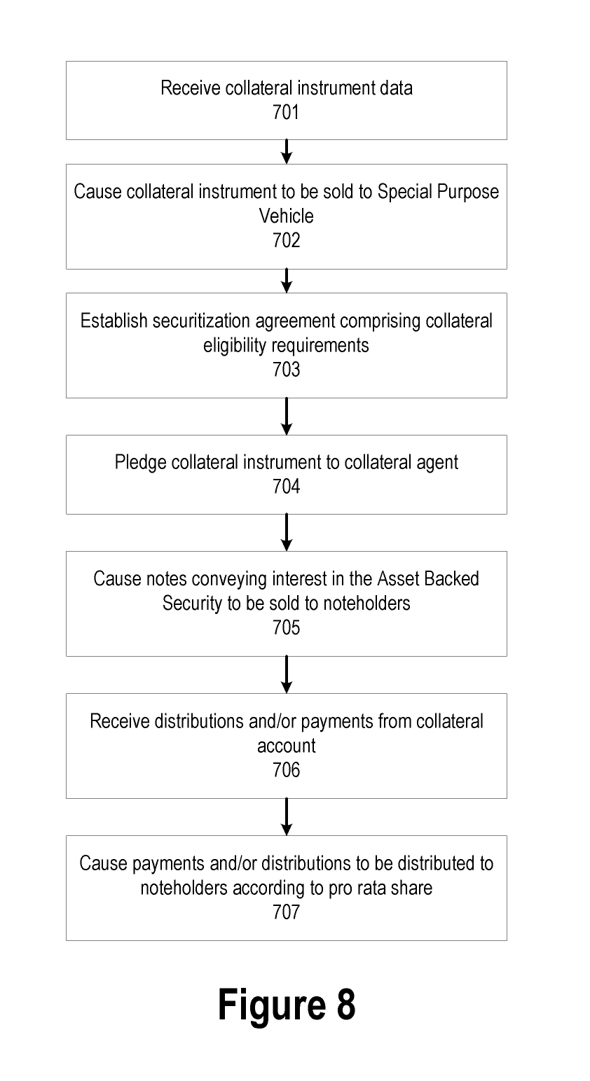

As illustrated in FIGS. 5 and 7, one or more collateral instruments 60 may be utilized to secure one or more asset backed securities 62 issued under the terms of a securitization. In various embodiments, the originator 51 may sell one or more collateral instruments 60, such as advances made under a loan, loans, or bundles of loans to an issuer 54, who may cause to be created asset backed securities 62 to be sold to noteholders 56, using the collateral instruments 60 to secure the asset backed securities 62. Additionally, at step 701 of FIG. 8, the issuer 54 (or another party associated with the securitization structure) may receive collateral instrument data 701 comprising information regarding the characteristics of the one or more collateral instruments 60. At step 702 of FIG. 8, the issuer 54 may subsequently sell the collateral instruments to a Special Purpose Vehicle (“SPV”) 55, such as a trust. Additionally, at step 703 the issuer may establish a securitization agreement comprising collateral eligibility requirements. The issuer 54 may also nominate an indenture trustee 56a to represent the interests of any current or subsequent owners of any interest in the SPV (e.g., noteholders 56 having an interest in the asset backed security 62).

In a manner similar to that related to the credit facility 61 described above, the issuer 54 may pledge the collateral instruments 60 to the collateral agent 57 at step 704 of FIG. 8, who may deposit any documentation in a collateral account 58 and may distribute any proceeds or distributions according to the terms of the securitization. In response to pledging the collateral to the collateral agent 57, the collateral agent 57 may grant a share in the collateral account 58 the debt product and/or one or more of the parties associated with the debt product. The share in the collateral account may be defined with reference to the value of the pledged collateral, or it may be defined in terms of a total interest level in the collateral account 58.

As a non-limiting example, if a party pledges collateral instruments with a value of $50 million to be deposited into the collateral account 58, the collateral agent 57 may grant the party a share in the collateral account 58 having a value of $50 million. As a second non-limiting example, if a party pledges collateral instruments generating $10,000 per month for 48 months to be deposited into the collateral account 58, the collateral agent 57 may grant the pledging party a share in the collateral account having the same earning potential. As yet another non-limiting example, if a party pledges collateral having a value of $50 million to be deposited in a collateral account 58, and consequently the value of the total collateral pledged to the collateral account equals $500 million after the newly pledged collateral is added, the collateral agent 57 may grant the pledging party a 10% interest in the collateral account.

The issuer 54 (or another party, such as investment bank) may subsequently sell (or cause to be sold) notes to prospective noteholders 56 at step 705 of FIG. 8, thus granting purchasing noteholders 56 a partial interest in the proceeds generated by the asset backed security 62. As will be understood by those skilled in the art, the partial interest owned by a single noteholder 56 is equivalent to the proportion of the number of notes owned by the noteholder 56 divided by the number of notes outstanding related to the asset backed security 62. In various embodiments, the issuer 54 or other party may issue notes in the asset backed security 62 according to various classes. As will be understood by those skilled in the art, each of the various classes may have different rights and/or characteristics attached thereto. As a non-limiting example, a first class may be entitled to a first distribution rate, and may include only collateral instruments with a first credit rating (as determined by a credit rating agency), and a second class may be entitled to a second distribution rate, and may include only collateral instruments with a second credit rating (as determined by a credit rating agency). In various embodiments, each class of notes may be paid in accordance with a priority of distributions. As a non-limiting example, the first class of notes may be paid in full prior to payment of the second class of notes.

Moreover, according to various embodiments, the securitization structure may specify one or more collateral eligibility requirements, by which collateral instruments 60 pledged to the collateral agent 57 and deposited in the collateral account 58 may be shared among a plurality of debt products. As described in greater detail herein, these collateral allocation rules may specify one or more required characteristics associated with a particular collateral instrument 60 for the collateral instrument to be utilized to secure the asset backed security 62. As non-limiting examples, the securitization structure may specify (1) a minimum and/or maximum credit rating for any collateral instrument to be used for collateral for the securitization (e.g., a Moody's rating of A2); (2) a minimum and/or maximum percentage interest in a single collateral instrument (e.g., the securitization requires that no more than 5% of any one collateral instrument be used as a portion of the collateral for the securitization); (3) a minimum and/or maximum percentage of underlying collateral that may be located in a particular region (e.g., no more than 5% of the total underlying collateral used to secure the collateral instruments may consist of real property located in California); (4) a minimum and/or maximum percentage interest in collateral instruments executed by a single obligor; and/or the like.

As described herein, the securitization structure may comprise one or more of such collateral eligibility requirements, and such rules may refer to any of a plurality of collateral instrument characteristics. In various embodiments, the collateral agent 57 may compare the characteristics of each of a plurality of collateral instruments 60 against the collateral eligibility requirements arising from the plurality of debt products, and may determine an optimal allocation of collateral among the plurality of debt products. In various embodiments, the collateral allocation may result in each debt product being adequately collateralized, such that at least the minimum value of collateral is associated with each debt product in the CCASIA.

At steps 706 and 707 of FIG. 8, the issuer 54 or other party representing the interests of the noteholders 56 (e.g., the indenture trustee 56a) may receive distributions and/or payments from the collateral account 58, and may cause these payments and/or distributions to be distributed to the noteholders 56 according to each noteholder's pro rata share.

In various embodiments, the securitization structure may define a replenishment period during which additional collateral may be added to the securitization in the event that an original collateral instrument 60 is paid off or enters default. During the replenishment period, which may constitute a period of time beginning on the closing date and extending for a predefined period of time, the collateral agent and/or the indenture trustee may purchase one or more additional collateral instruments in the event that a collateral instrument 60 previously associated with the securitization structure is paid prematurely and/or a collateral instrument previously associated with the securitization structure enters default. As will be understood by those skilled in the art, the one or more additional collateral instruments 60 may be purchased using proceeds received from the premature payoff and/or liquidation procedure. Alternatively, the additional collateral instruments may be purchased using funds from a replenishment account, which may be associated with the securitization structure.

Collateral Module

As illustrated in FIG. 10, the Collateral Module 200 may be configured to receive collateral data regarding at least a portion of the collateral instruments associated with the collateral sharing arrangement at Block 201. The Collateral Module 200 may store the collateral data in a data table including various rows or columns each containing characteristics of a particular collateral instrument, or the Collateral Module 200 may maintain a database containing collateral instrument profiles, records and/or the like (referred to herein as “profiles”), each profile containing information regarding the characteristics of the collateral instrument. As will be understood by those skilled in the art, the Collateral Module 200 may be configured to store collateral data regarding collateral used in separate credit sharing agreements in separate databases or other storage media, or the Collateral Module 200 may be configured to store collateral data regarding collateral used in different CCASIAs in one or more common databases or common storage media, and indicating the corresponding CCASIA to which a particular collateral instrument 60 is associated. As shown at Block 202 of FIG. 10, the Collateral Module 200 may be configured to receive updated data regarding the characteristics of each collateral instrument 60 from external sources (e.g., credit rating agencies) and/or from other program modules included in the computer system.

As illustrated as Block 201 of FIG. 10, the Collateral Module 200 may be configured to receive initial collateral data including characteristics of a collateral instrument when the collateral instrument is initially associated with the CCASIA (e.g., when the collateral instrument 60 is deposited into the collateral account 58. This information may be received as input to the computer system utilizing a local computing device 110, it may be read utilizing an optical scanner utilized to read information from debt product documentation (e.g., a credit agreement), or it may be received as input from an external source (e.g., the originator 51 associated with the collateral instrument 60), or another program module included in the computer system. As a non-limiting example, the data received by the Collateral Module 200 may be stored in a relational database in communication with the server 120. Moreover, in various embodiments, the Collateral Module 200 may be configured to store data regarding the documentation associated with the original collateral instrument. As non-limiting examples, the Collateral Module 200 may be configured to store copies of the original documentation associated with the collateral instrument 60, location data regarding the expected location of the original documentation, the text of the original documentation, and/or the like.

The data received by the Collateral Module 200 may be stored as collateral data in one or more data tables, or it may be included in one or more collateral instrument profiles comprising data regarding characteristics of one or more collateral instruments 60. As will be understood by those skilled in the art, the collateral data comprising characteristics of a particular collateral instrument 60 received and stored by the Collateral Module 200 may depend on collateral allocation rules defined in the plurality of debt products associated with the CCASIA and/or on the collateral instrument 60 itself. As a non-limiting example, the characteristics of a commercial loan agreement having multiple advances granted to a particular commercial entity may have different characteristics than an aggregated collection of home loans each granted to individual homeowners or a premium loan granted to an entity in order to finance a life insurance policy for a particular individual. However, in various embodiments, collateral data comprising data regarding each of these differing types of collateral instruments may comprise at least one common collateral instrument characteristic, such as a credit rating as determined by a particular credit rating agency.

As non-limiting examples, collateral data comprising characteristics of a particular collateral instrument received and maintained by the Collateral Module 200 may comprise at least one of: (1) the value of outstanding debt left on the collateral instrument, (2) the type of underlying collateral securing the collateral instrument (e.g., a vehicle may be used to secure a vehicle loan, a home may be used to secure a home mortgage, a company's inventory may be used to secure one or more advances granted under a commercial loan, and/or the like), (3) the location of the underlying collateral used to secure the collateral instrument (e.g., the country, state, and/or street address of a home used to secure a home loan), (4) the value of the underlying collateral used to secure the collateral instrument, (5) additional characteristics of the underlying collateral used to secure the collateral instrument (e.g., the model year, make and/or model of the vehicle used to secure the vehicle loan; or the size of the home used to secure a home loan), (6) the identity of the obligor associated with the collateral instrument, (7) additional characteristics of the obligor (e.g., the obligor's profession, age, income, net worth, market cap, and/or the like), (8) the identity of the originator of the collateral instrument, (9) additional characteristics of the originator (e.g., the originator's net worth, market cap, and/or the like), (10) the credit rating of the collateral instrument (e.g., as defined by Moody's, Standard & Poor's, and/or the like), (11) the value of any additional cash collateral provided by the borrower, and/or the like.

As previously noted, the Collateral Module 200 may receive and maintain data regarding characteristics of the collateral instrument that may be specific to a particular type of collateral instrument. As non-limiting examples, the Collateral Module 200 may receive data regarding premium loans used to finance the purchase of life insurance policies. As specific non-limiting examples of characteristics that may be received and maintained by the Collateral Module 200 that are specific to premium loans used to finance life insurance policies, the Collateral Module 200 may receive and maintain collateral data comprising characteristics of a collateral instrument such as (1) the actual cash surrender value of the life insurance policy used as underlying collateral for the collateral instrument, (2) the maturity date of the insurance policy, (3) the actual gap rider value of the life insurance policy, (4) the value of an insurer account for the life insurance policy, (5) the value of assets contained in a gap reserve account, (6) the identity of the life insurance carrier, (7) the credit rating of the insurance carrier, and/or the like. Moreover, as previously indicated, the Collateral Module 200 may receive allocation data from other modules regarding the allocation of a particular collateral instrument among a plurality of debt products. As a non-limiting example, the Collateral Module 200 may receive allocation data regarding the interests in a particular collateral instrument attributable to each of the plurality of interested debt products.

In various embodiments, the Collateral Module 200 may be configured to receive updated collateral instrument characteristic data at any of a variety of periods in time. In various embodiments, the Collateral Module 200 may be configured to receive updated data when external sources and/or other program modules in the computer system “push” data to the Collateral Module 200. Accordingly, the Collateral Module 200 may receive updated data (e.g., updated collateral data) constantly and/or instantaneously to reflect a current status of each collateral instrument (e.g., data reflective updated collateral characteristics). Thus, as discussed herein, the allocation of collateral may remain in constant compliance with applicable rules, regulations, laws, and/or collateral eligibility requirements corresponding to particular debt products. Alternatively, the Collateral Module 200 may be configured to periodically (e.g., every hour, day, week, month, and/or the like) check the various external sources and other program modules in the computer system to determine whether updated collateral data exists for any of the collateral instruments associated with the credit sharing agreement. For example, the Collateral Module 200 may receive collateral data regarding an updated credit rating as determined by at least one rating agency when the updated credit rating data is pushed to the Collateral Module 200. Alternatively, the Collateral Module 200 may determine that updated credit rating data for a particular collateral instrument is available during one or more periodic checks of the credit rating agency data. In various embodiments, the Collateral Module 200 may be configured to receive data indicating that a particular lending institution is leaving the CCASIA, and consequently, at least a portion of the collateral instruments utilized therein may be removed from the total number of collateral instruments. The Collateral Module 200 may also be configured to receive data indicating that a new lending institution is entering the CCASIA, and additional collateral instruments are entered into the total number of collateral instruments.

Once the updated collateral data is received, the Collateral Module 200 may proceed to update the stored collateral data to reflect the updated data. As will be understood by those skilled in the art, the step of updating the stored collateral data may include the step of adding new information to the stored collateral data, replacing existing data, and/or removing existing data.

Additionally, as illustrated at Block 203 of FIG. 10, the Collateral Module 200 may be configured to receive input from the Allocation Module 400, the features and functionality of which is described in greater detail herein, and may be configured to store allocation data in association with the collateral data. As will be described in greater detail herein, the Allocation Module 400 may be configured to allocate interests in one or more collateral instruments 60 among a plurality of debt products. In various embodiments, the Allocation Module 400 may be configured to receive and utilize allocation rules from the Debt Product Module 300 regarding acceptable levels of interest for a particular debt product in any one particular collateral instrument. Thus, the Collateral Module 200 may be configured to receive data from the Allocation Module 400 regarding established links between collateral data and debt product data reflected in a database. Thus, the Collateral Module 200 may receive data regarding the credit agreements and/or securitizations having an interest in a particular collateral instrument, and each debt product's level of interest in the particular collateral instrument. As noted herein, the Collateral Module 200 may be configured to receive updated allocation data from the Allocation Module 400 when the Allocation Module 400 “pushes” data to the Collateral Module 200. Alternatively, the Collateral Module 200 may be configured to periodically (e.g., every hour, day, week, month, and/or the like) check the Allocation Module 400 to determine whether updated allocation data exists for any of the collateral instruments associated with the credit sharing agreement. Accordingly, in various embodiments the Collateral Module 200 may be configured to ensure that collateral data stored therein is reflective of updated collateral characteristics (e.g., updated in realtime) such that links established between collateral data and debt product data stored within the database may be updated instantaneously in response to changes in collateral data such that the data stored in the database remains in constant compliance with applicable rules, regulations, laws, and/or collateral eligibility requirements corresponding to particular debt products.

As will be understood by those skilled in the art, the allocation data may be stored in the same database or storage media as the collateral data, or it may be stored in a separate database or storage media, with appropriate designations referring to the relevant collateral instruments 60 and debt products. In various embodiments, the allocation data may be stored as a subset of the collateral data, and may define the levels of interest of each interested debt product as a particular collateral instrument characteristic.

Moreover, in various embodiments, the Collateral Module 200 may be configured to output one or more reports regarding the collateral data. In various embodiments, the reports may be automatically generated at various times, such as hourly, daily, weekly, monthly, or in response to the happening of some predefined event, such as the introduction of a new collateral instrument, or the payoff of a debt existing under an included collateral instrument. Alternatively, the reports may be generated in response to a user input. In various embodiments, the reports may comprise summary information, such as the total outstanding debt existing under the terms of the included collateral instruments, the total number of collateral instruments of a particular type (e.g., the total number of commercial loan advances being used as collateral instruments), expressed as either a total number of collateral instruments meeting the applicable criteria, as a percentage of the total number of collateral instruments, or as a percentage of the total value of collateral instruments (e.g., 10% of the total value of all included collateral instruments arises from commercial loan advances).

Debt Product Module

In various embodiments, the Debt Product Module 300 may be configured to receive debt product data comprising characteristics of each credit agreement and/or securitization structure included in the CCASIA. The Debt Product Module 300 may store the debt product data in a data table including various rows or columns each containing characteristics of a particular credit agreement and/or securitization, or the Debt Product Module 300 may maintain a database containing debt product profiles, each profile containing information regarding the characteristics of the particular credit agreement or securitization. As will be understood by those skilled in the art, the Debt Product Module 300 may be configured to store debt product data regarding debt products associated with separate credit sharing agreements in separate databases or other storage media, or the Debt Product Module 300 may be configured to store debt product data regarding debt products associated with different CCASIAs in one or more common databases or common storage media, and indicating the corresponding CCASIA as a debt product characteristic. The Debt Product Module 300 may be configured to receive updated debt product data regarding the characteristics of each credit agreement and/or securitization from external sources (e.g., lending institutions) and/or from other program modules included in the computer system. In various embodiments, the Debt Product Module 300 may also be configured to receive and store contact information (e.g., physical address, mailing address, telephone number for an agent of a party, email address for an agent of a party, and/or facsimile number for an agent of a party) for one or more of the parties interested in each debt product (e.g., the borrower's contact information and/or the lending institution's contact information). As will be understood by those skilled in the art, the party contact information may be stored together with debt product data as a debt product characteristic, or it may be stored separately in a database or other storage media used for storing party contact information.

As illustrated in FIG. 10, the Debt Product Module 300 may be configured to receive initial characteristics of a credit agreement and/or securitization when the credit agreement and/or securitization is associated with the CCASIA. This information may be received as input to the computer system utilizing a local computing device 110, it may be read utilizing an optical scanner utilized to read information from a debt product document, or it may be received as input from an external source (e.g., a lending institution associated with a credit agreement) or another program module included in the computer system. The data received by the Debt Product Module 300 may be stored in one or more data tables and/or databases associated with the computer system 100. As a non-limiting example, the data received by the Debt Product Module 300 may be stored in a relational database in communication with the server 120. Moreover, in various embodiments, the Debt Product Module 300 may be configured to store data regarding the documentation associated with the original credit agreement. As non-limiting examples, the Debt Product Module 300 may be configured to store copies of the original debt product documentation, location data regarding the expected location of the original debt product documentation, the text of the original debt product documentation, and/or the like.

The debt product data received by the Debt Product Module 300 may be stored as debt product data in one or more data tables, or it may be included as a debt product profile comprising data regarding characteristics of the debt product. As will be understood by those skilled in the art, the characteristics of a particular debt product received and stored by the Debt Product Module 300 may depend on information contained in a collateral instrument 60 being used to secure the debt underlying the debt product.

As non-limiting examples shown in Blocks 301 and 302 of FIG. 10, characteristics of a particular credit agreement and/or securitization received and maintained by the Debt Product Module 300 may comprise at least one of: (1) the type of agreement involved (e.g., a credit facility, a securitization structure, commercial paper, and/or the like), (2) the value of the agreement involved, (3) the number of advances available under the terms of the agreement, (4) the identities of the parties involved, (5) how distributions resulting from the underlying collateral instruments are allocated between the borrower and the lending institution, (6) the term of the debt product, (7) collateral allocation rules, and/or the like. As discussed herein, the characteristics (e.g., collateral allocation rules) may define various database management criteria by which links are established between collateral data and debt product data to reflect an allocation of collateral among a plurality of debt products. As will be described in greater detail herein, the Debt Product Module 300 may be configured to transmit allocation rule data to the Allocation Module 400 for use therein.

In various embodiments, the collateral allocation rules may be utilized in determining an optimal allocation of collateral included in the collateral account 58 among a plurality of credit agreements and/or securitizations. In various embodiments, the collateral allocation rules are utilized as database management criteria for establishing/mapping links between data (e.g., between collateral data and debt product data) to reflect the optimal allocation. The collateral allocation rules may define characteristics of acceptable collateral instruments 60 that may be utilized as collateral for the debt product. In various embodiments, the number and type of collateral allocation rules that may be incorporated into a debt product (and consequently utilized during the allocation process) may be dictated by the number and type of collateral instrument characteristics received and stored by the Collateral Module 200 as collateral data. However, in various embodiments, the Collateral Module 200 may be reconfigured to receive and store new or additional collateral data comprising collateral instrument characteristics in response to a determination that one or more debt products comprise one or more collateral allocation rules referencing one or more collateral instrument characteristics not presently included in the collateral data stored by the Collateral Module 200.

As non-limiting examples, the collateral allocation rules received and stored by the Debt Product Module 300 may comprise: (1) a minimum and/or maximum credit rating (as determined by a credit rating agency) of a collateral instrument to be used as collateral, (2) a minimum and/or maximum level of interest in any one collateral instrument (e.g., a credit agreement may specify that no more than a 20% interest in any one collateral instrument may be used as collateral for at least a portion of the collateral), (3) a geographic limitation (e.g., a maximum or minimum percentage of the total collateral utilized to secure the debt underlying the debt product may utilize underlying collateral located in California), (4) a minimum and/or maximum level of interest in collateral instruments involving a single obligor (e.g., a credit agreement may specify that no more than 15% of the total collateral utilized to secure the debt underlying the credit agreement may include repayment obligations of Company A), (5) a minimum and/or maximum recovery rate in the event of a default of the collateral instrument, (6) a minimum and/or maximum coupon rate, (7) an acceptable range of maturity dates (e.g., a maturity date no earlier than 12 months from a predetermined date), (8) compliance with one or more representations and/or warranties included in the debt product, (9) a minimum and/or maximum granularity for obligors or carriers (granularity is explained in greater detail herein), (10) a minimum and/or maximum carrier concentration, (11) a minimum and/or maximum financial strength rating of an underlying carrier, and/or the like; and (12) compliance with applicable regulatory requirements, including without limitations equity and capital requirements of the various parties.

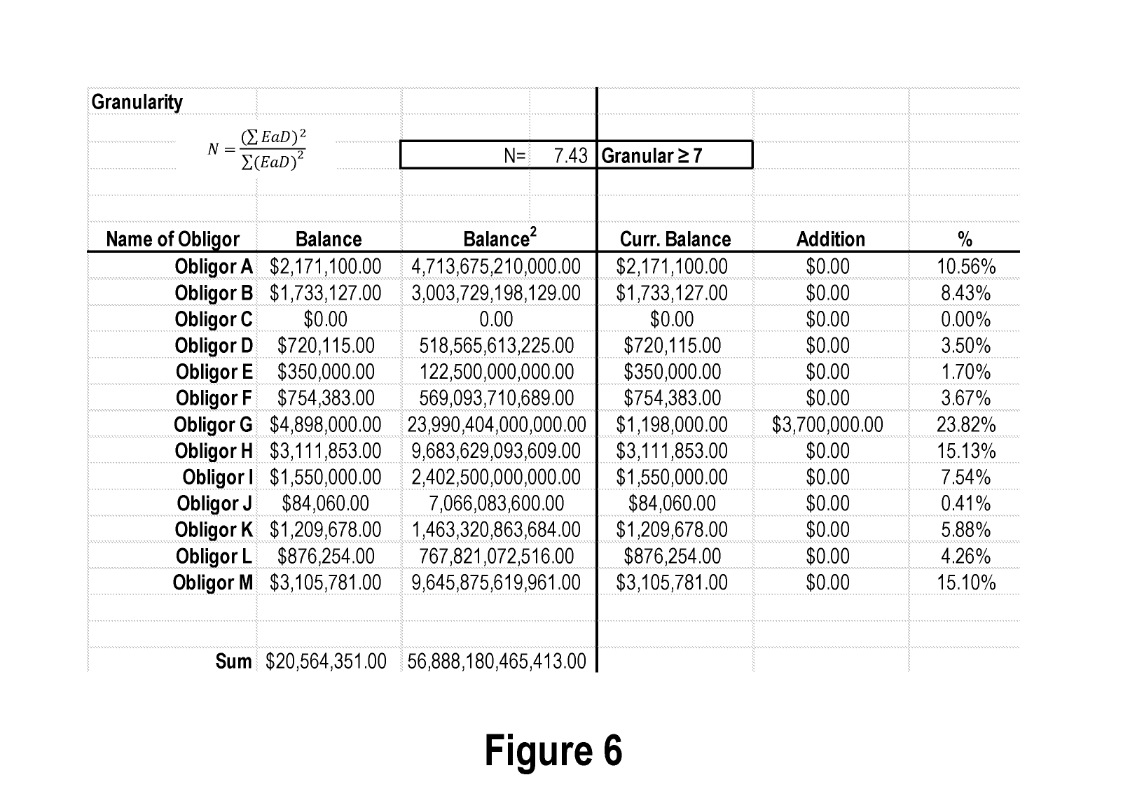

In various embodiments, the granularity may be embodied as a summary value used to describe the concentration of collateral instruments having a particular characteristic (e.g., executed by a single obligor, associated with a particular insurance carrier, and/or the like). In various embodiments, the granularity value may be calculated for a given set of collateral instruments 60 being used as collateral for a particular debt product. FIG. 6 illustrates an exemplary granularity calculation according to various embodiments. Moreover, in various embodiments, a regulatory entity may define a minimum granularity value for various asset backed securities and/or other debt products. As will be described in greater detail herein, the Allocation Module 400 may be configured to incorporate any regulatory requirements (such as granularity requirements, requirements under credit risk retention rules for securitizations (e.g., rules specifying a minimum level of credit risk that must be retained by an issuer), and/or the like) into the determination of an optimal allocation of collateral instruments among a plurality of debt products. The granularity value for a given set of collateral instruments may be calculated based on the value of the interest in each collateral instrument attributable to the debt product. In various embodiments, a low granularity value, such as a granularity value approaching a value of 1, may indicate a high concentration of collateral in a single obligor or carrier. Therefore, in various embodiments, a debt product may indicate a minimum granularity value based on their interests in various collateral instruments in order to mitigate any detrimental effects of, for example, a single obligor defaulting on payments of a collateral instrument.

In various embodiments, the Debt Product Module 300 may be configured to receive updated debt product data at various instances in time. In various embodiments, the Debt Product Module 300 may be configured to receive updated data when external sources and/or other program modules in the computer system “push” data to the Debt Product Module 300. Accordingly, the Debt Product Module 300 may be configured to receive real-time, constant and/or instantaneous updates to reflect changes to the underlying debt products. Accordingly, the Debt Product Module 300 ensures that data corresponding to each debt product remains updated, such that links established between various collateral data and debt product data in the database remain in constant compliance with applicable rules, regulations, laws, and/or collateral eligibility requirements corresponding to particular debt products. Alternatively, the Debt Product Module 300 may be configured to periodically (e.g., every hour, day, week, month, and/or the like) check the various external sources and other program modules in the computer system to determine whether updated debt product data exists for any of the debt products associated with the credit sharing agreement. For example, the Debt Product Module 300 may receive data regarding updated collateral allocation rules to be applied in allocating collateral instruments to a particular debt product.

In various embodiments, the compliance with applicable regulatory requirements may be embodied as a calculations, measurements, standards and monitoring of data from the CCASIA to determine lender capital requirements, borrower equity requirements and the like that satisfy applicable regulations under Basel III, the Dodd Frank Wall Street Reform and Consumer Protection Act, and similar applicable legal requirements. Moreover, in various embodiments, a regulatory authority may define minimum equity requirements for various asset backed securities and/or other debt products, and the system may be configured to calculate and analyze methods of satisfying such requirements. As a non-limiting example, the system data may indicate that the equity requirement is satisfied by calculating and using the net present value of excess spread of the debt product, reserve accounts required by the lenders, affiliate guarantees, or other available resources in order to determine the optimal method of compliance within a given securitization or among all securitizations included in the CCASIA.

In addition to receiving updated debt product data, the Debt Product Module 300 may be configured to receive data indicating a particular lending institution is exiting the CCASIA, as illustrated at Block 303 of FIG. 10. In response to receiving such data, the Debt Product Module 300 may be configured to transmit corresponding change data to the Allocation Module 400 indicating that a lender is leaving the CCASIA, and consequently a new collateral allocation is necessary. Moreover, upon a lending institution leaving the CCASIA, the Debt Products Module 300 may be configured to determine a buyout amount that must be paid to the lending institution (or other party) to reimburse the lending institution for the collateral pledged to the collateral account 58. In various embodiments, the Debt Product Module 300 may be configured to generate and transmit a notification to a user comprising the buyout amount to be paid to the lending institution. In various embodiments, the Debt Product Module 300 may identify one or more assets (e.g., currency, collateral instruments 60, and/or the like) that may be utilized to satisfy the buyout amount. The assets may be identified as being pledged to the collateral account, or they may be owned by a third party entity, such that the Debt Product Module 300 may identify a party that may be interested in purchasing the leaving entity's share in the collateral account 58.

The Debt Product Module 300 may additionally receive and store contact information for at least one of the parties interested in a particular debt product. In various embodiments, the Debt Product Module 300 may cause a communication to be sent to at least one party, using the stored contact information. As will be described herein, the Allocation Module 400 and/or the Notification and Alerts Module 500 may utilize the contact information for the parties to cause communications to be sent to the parties periodically (e.g., daily, weekly, monthly, and/or the like) or upon the happening of a predetermined event (e.g., the prepayment of a collateral instrument being used to secure a credit agreement).

Allocation Module

In various embodiments, the Allocation Module 400 may be configured to receive data from the Collateral Module 200 and the Debt Product Module 300, as illustrated at Blocks 401 and 402 of FIG. 10. Specifically, the Allocation Module 400 may receive collateral data from the Collateral Module 200, and may receive debt product data comprising collateral allocation rules from the Debt Product Module 300. In various embodiments, the Allocation Module 400 may additionally be configured to receive regulatory requirements defined by a regulatory entity regarding collateral allocation, loan requirements, securitization requirements, credit risk retention requirements, and/or the like. As illustrated at Block 403 of FIG. 10, the Allocation Module 400 may be configured to compare collateral instrument characteristics identified in the collateral data, the collateral allocation rules identified in the debt product data, and the regulatory requirements, and based on this comparison, determine an optimal allocation of collateral instruments among the plurality of debt products included in the credit sharing agreement. The Allocation Module 400 may establish links between data stored in the database to reflect the optimal allocation. The optimal allocation may be highly fluid and/or dynamic and reflective of a current collateral data and debt product data to remain constant compliance with applicable rules, regulations, laws, and/or collateral eligibility requirements corresponding to particular debt products. As will be understood by those skilled in the art, the comparison and determination steps may be accomplished using an iterative algorithm configured to determine whether each of the collateral allocation rules supplied by each debt product are satisfied by a particular allocation of collateral instruments. The comparison and determination steps may be performed periodically (e.g., hourly, daily, weekly, and/or monthly) at predetermined intervals to ensure compliance with each of the collateral allocation rules over time.

The Allocation Module 400 may additionally be configured to maintain allocation data indicating the collateral associated with each credit agreement and/or securitization. The allocation data may include data regarding the level of interest in each collateral instrument associated with each credit agreement and/or securitization. As a non-limiting example, the allocation data may indicate which of the plurality of credit agreements and/or securitizations have an interest in each collateral instrument and the level of interest in each collateral instrument associated with each credit agreement and/or securitization (e.g., the percentage interest and/or value of the interest associated with each debt product).

The Allocation Module 400 may be configured to create a pari passu collateral allocation among each of the credit agreements and/or securitizations included in the CCASIA. In various embodiments, the pari passu collateral allocation may define the portions of each collateral instrument 60 to be associated with each credit agreement and/or securitization as collateral therefor. As indicated herein, the Allocation Module 400 may be configured to transmit the allocation data to the Collateral Module 200 for storage therein.

Moreover, the Allocation Module 400 may be configured to maintain subordination data regarding the subordinated parties each having an interest in a particular collateral instrument. As will be understood by those skilled in the art, a subordinated party may have a subordinated interest in the collateral instruments associated with a given credit agreement. In various embodiments, the subordinated party's interest may extend to the same portions of each collateral instrument securing the credit agreement. The subordination data may define a payout scheme under which payments made to particular parties are made in an order such that a party having the highest payout priority (i.e., a party holding an interest in the highest tranche) may be paid in full such that the party's interest is fully satisfied before payments are made to parties having interests in lower tranches.

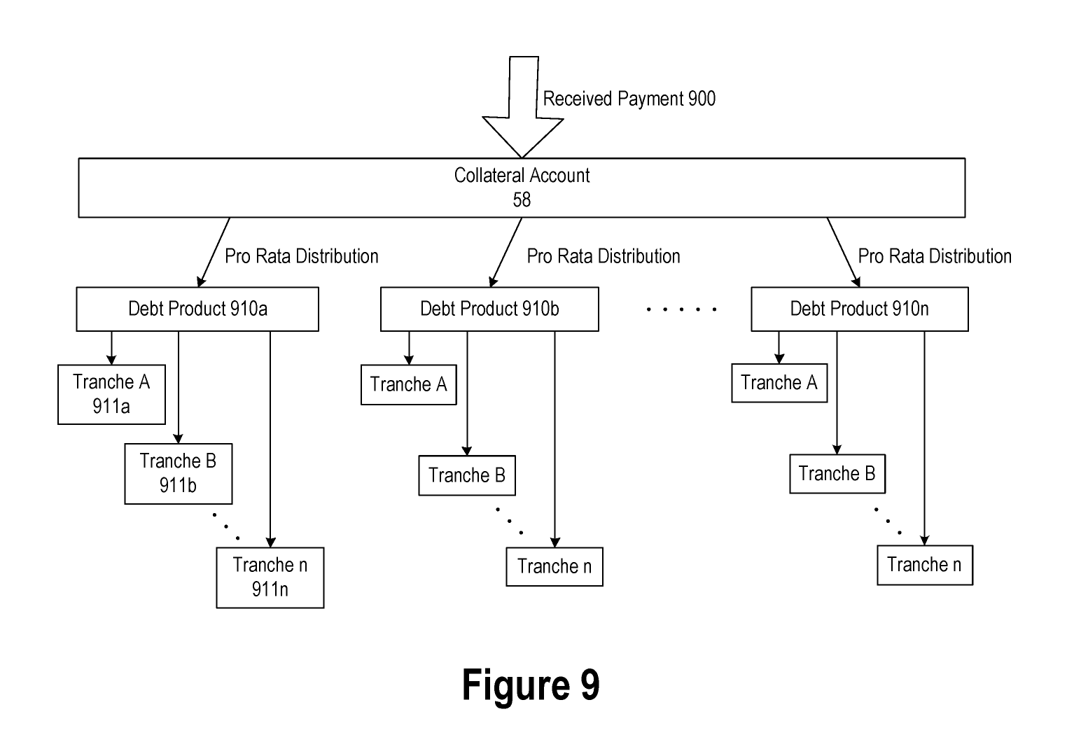

As shown in FIG. 9, a received payment 900 may be associated with the collateral account 58. Based on the collateral allocation and each debt product's pro rata share in the received payment 900, the received payment may be distributed among the plurality of debt products 910a, 910b, . . . 910n according to a pari passu distribution. The portion of the received payment 900 distributed to each debt product 910a, 910b, 910n may then be further distributed among those parties having an interest in the debt product, according to a tranche-based distribution. The order in which parties receive payments may be defined in the debt product agreement (e.g., securitization agreement or credit facility agreement). As a non-limiting example, a first party or group of parties (collectively referred to as “tranche A” parties 911a) may be paid in full before parties in other tranches are paid. After the tranche A parties are paid in full, a second party or group of parties (collectively referred to as “tranche B” parties 912a) receive payments. Only after all tranche B parties 913b are paid in full are parties have interests in additional tranches 911n paid. This process may continue until parties having interests in all tranches are paid, or until the funds distributed to the debt product under the pari passu distribution are exhausted. As a non-limiting example, Tranche A may comprise administrative parties (e.g., a collateral agent, servicer, and/or the like), who may be entitled to a predetermined percentage of any payments received. Tranche B may comprise parties having the highest rated notes in a particular debt product (e.g., noteholders having the lowest risk notes in an asset backed security). Additional tranches may comprise noteholders having lower quality notes. As will be understood by those skilled in the art, distributions among parties within a single tranche (e.g., Tranche B 911b), may be made according to a pari passu distribution defined by each party's pro rata interest in the tranche. Alternatively, parties may agree in a debt product agreement that distributions among all parties having an interest in a particular debt product may be made according to a pari passu distribution according to each party's pro rata interest in the debt product.

In various embodiments, the Allocation Module 400 may be configured to receive exit data from the Debt Product Module 300 indicating that one or more parties (e.g., lending institutions) are exiting the CCASIA, and therefore the interests in the collateral account 58 associated with the one or more debt products being removed from the CCASIA must be purchased. In various embodiments, the purchase of the interests at issue may be accomplished by allocating one or more collateral instruments 60 to the debt products being removed from the CCASIA having a value at least equal to the value of the associated interest in the collateral account 58. Alternatively, the purchase may be accomplished by receiving assets from one or more third parties, which may be previously associated with the CCASIA, but need not be so affiliated. In various embodiments, the Allocation Module 400 may reflect the occurrence of exit data instantaneously by relinking the data in the database to reflect an updated allocation that ensures constant compliance with applicable rules, regulations, laws, and/or collateral eligibility requirements corresponding to particular debt products.

In various embodiments, the CCASIA may specify that in the event of a particular debt product being removed from the collateral account 58, other parties having an interest in the collateral account 58 must contributed at least some assets to be used to purchase the leaving party's interest. As a non-limiting example, the CCASIA may specify that each remaining party contributes an amount determined at least in part by each remaining party's pro rata interest in the collateral instruments remaining in the collateral account. As an additional non-limiting example, the CCASIA may specify that each remaining party having an interest in the removed collateral instruments contributes an amount determined at least in part by each remaining party's pro rata interest in the removed collateral instrument. As a specific example, if four parties each have a 25% interest in a particular collateral instrument, and one of the four interested parties removes the collateral instrument from the collateral account, the remaining three parties each contribute an amount equal to 25% of the value of the removed collateral, regardless of the total number of parties involved in the CCASIA. In various embodiments, upon the exit of a debt product associated with the CCASIA, the collateral account 58 may be liquidated and the proceeds from the liquidation may be distributed to those parties having an interest in the collateral account 58 in amounts corresponding to each party's pro rata interest in the collateral account 58.

In various embodiments, the Allocation Module 400 may be configured to determine an appropriate method of compensating the exiting party for the associated interest in the collateral account 58 based at least in part on the collateral data and debt product data. As a non-limiting example, the Allocation Module 400 may be configured to determine whether the exit of a particular lender, and the consequential changes in collateral allocation rules associated with the CCASIA, allows for a new collateral allocation satisfying the remaining collateral allocation rules.

The Allocation Module 400 may also be configured to receive entry data from the Debt Products Module 300 indicating that one or more parties (e.g., lending institutions) is associating one or more additional debt products with the CCASIA, and therefore additional collateral instruments must be distributed among the various debt products associated with the CCASIA. In various embodiments, the reallocation of the existing one or more collateral instruments 60, and the initial allocation of the one or more new collateral instruments may be accomplished in a manner similar to the initial allocation, as described herein. In various embodiments, the Allocation Module 400 may be configured to receive collateral data from the Collateral Module 200 indicating characteristics of the newly added collateral instruments, and may receive additional debt product data from the Debt Product Module 300 indicating collateral allocation rules associated with the newly added debt product. Utilizing this newly received collateral data and debt product data with the collateral data and debt product data regarding collateral instruments and debt products previously associated with the CCASIA, the Allocation Module 400 may determine an optimal allocation of collateral instruments among the plurality of debt products such that each of the collateral allocation rules may be satisfied. In various embodiments, the Allocation Module 400 may reflect the occurrence of entrance data instantaneously by relinking the data in the database to reflect an updated allocation that ensures constant compliance with applicable rules, regulations, laws, and/or collateral eligibility requirements corresponding to particular debt products (e.g., including the newly added debt products).

In various embodiments, upon the determination that each of the collateral allocation rules associated with the debt products remaining in the CCASIA cannot be satisfied, the Allocation Module 400 may be configured to transmit error data to the Notification and Alerts Module 500 for generation of an alert to be sent to at least one user indicating such conflicts exist. Such determination that each of the collateral allocation rules cannot be satisfied may result from the addition or removal of one or more collateral instruments from the collateral account. Upon the determination that each of the collateral allocation rules may be satisfied, the Allocation Module 400 may be configured to determine an optimal new allocation, and may, in various embodiments, transmit success data to the Notification and Alerts Module 500 for generation of a notification to at least one user indicating that no conflicts exist.

As a non-limiting example, a collateral allocation rule associated with a first debt product currently present in the CCASIA may require at least a 20% interest in an identified collateral instrument. Upon the addition of a new debt product and new collateral instruments, the Allocation Module 400 may determine an optimal allocation of collateral results in the first debt product's interest in the identified collateral instrument to fall below 20%. In such a circumstance, the Allocation Module 400 may be configured to transmit error data to the Notification and Alerts Module 500 for generation of an alert to be sent to at least one user indicating such conflict exists.

As a second non-limiting example, the addition of a new debt product and new collateral instruments may require one or more existing collateral instruments to be shifted among a plurality of debt products in order to satisfy the collateral allocation requirements of the plurality of included debt products. Such a waterfall effect, wherein interests in several collateral instruments are shifted among a plurality of debt products, may be necessary in order to achieve an optimal allocation upon the entrance or exit of one or more collateral instruments and/or debt products.

Due to the occurrence of potentially incompatible collateral allocation rules supplied by the plurality of debt products (as a non-limiting example, in a CCASIA wherein two debt products require a 60% interest in a single identified collateral instrument), the optimal allocation determined by the Allocation Module 400 may define an allocation of collateral instruments that most nearly comports with each of the collateral allocation rules provided by the plurality of debt products. In response to a determination that such an optimal allocation is utilized, the Allocation Module 400 may be configured to identify those debt products that are under-collateralized and therefore the value of the collateral securing the debt product is less than the value of the debt product itself. The Allocation Module 400 may be configured to transmit under-collateralization data identifying the under-collateralized debt products to the Notification and Alerts Module 500 in order to contact at least one of the impacted parties.

Alternatively, in response to a determination that at least one debt product is under-collateralized as a result of the determined optimal allocation, the Allocation Module 400 may be configured to determine a secondary allocation, under which at least one collateral allocation rule may be changed such that each of the collateral allocation rules may be satisfied. In determining a secondary allocation, the Allocation Module 400 may identify possible collateral allocation rules that may be changed in order to enable the Allocation Module 400 to fully comply with all collateral allocation rules. As will be understood by those skilled in the art, a debt product defining a collateral allocation rule that may be changed need not be an under-collateralized debt product. As a non-limiting example, the Allocation Module 400 may determine that a securitization structure is under-collateralized in an optimal allocation, and may determine that the collateral allocation rules defined by the securitization may not be changed. However, in determining a secondary allocation, the Allocation Module 400 may identify a collateral allocation rule defined in a credit facility agreement between two commercial entities that, if changed, would result in an optimal allocation under which each of the collateral allocation rules are satisfied.

In various embodiments, the Allocation Module 400 may be configured such that the Allocation Module 400 will not determine a collateral allocation in response to a determination that each of the collateral allocation rules cannot be satisfied. In response to a determination that no collateral allocation will be generated, the Allocation Module 400 may be configured to transmit error data to the Notification and Alerts Module 500 indicating that no collateral allocation is possible. As will be described herein, the Notification and Alerts Module 500 may be configured to alert at least one of the affected parties. In such circumstances, the Allocation Module 400 may additionally be configured to determine repurchase options under which a party may agree to purchase the interest in at least one collateral instrument that does not qualify as eligible collateral under at least one debt product defining collateral allocation requirements. In various embodiments, the repurchase options may identify potential parties that may purchase the interest in at least one ineligible collateral instrument. As a non-limiting example, the Allocation Module 400 may identify the originator 51 as a repurchasing party under at least one repurchase option. As will be understood by those skilled in the art, in circumstances in which the originator 51 (or another party) repurchases at least one ineligible collateral instrument, the originator (or other party) may sell the repurchased collateral instruments to another third party.

Alternatively, in response to a determination that the Allocation Module 400 cannot satisfy each of the collateral allocation rules, the Allocation Module 400 may be configured to determine a collateral allocation that satisfies (a) the largest possible number of debt products, (b) the largest percentage of parties associated with the CCASIA, (c) the largest value debt products first, (d) the smallest value debt products first, and/or the like. In response to such a determination, the Allocation Module 400 may be configured to transmit under-collateralization data to the Notification and Alerts Module 500 indicating that at least one debt product is under-collateralized. As will be described herein, the Notification and Alerts Module 500 may be configured to alert at least one of the affected parties.

In various embodiments, the Allocation Module 400 may be configured to identify possible solutions for generating an allocation satisfying each of the collateral allocation rules provided by the plurality of debt products. In various embodiments, the CCASIA may define solution parameters by which the Allocation Module 400 may ascertain an appropriate solution for generating an allocation satisfying each of the collateral allocation rules provided by the plurality of debt products. The parties to the CCASIA (e.g., a borrower 52, a lending institution 53, an issuer 54, a collateral agent 57, and/or the like) may determine appropriate solution parameters to be utilized by the Allocation Module 400. As a non-limiting example, the Allocation Module 400 may be configured to identify potential collateral allocation rule changes and/or rule exceptions that may result in an allocation meeting the requirements of each of the collateral allocation rules. In various embodiments, a lending institution 53 may grant an exception and allow an identified collateral instrument 60 to be used as collateral for an identified debt product. In various embodiments, the Allocation Module 400 may be configured to identify potential collateral instrument buyouts, wherein one party (which may or may not be associated with the CCASIA) may agree to purchase an interest in a collateral instrument that does not satisfy the collateral allocation rules. The funds resulting from the collateral instrument interest purchase may be distributed among at least a portion of the under-collateralized debt products. As will be understood by those skilled in the art, the Allocation Module 400 may identify a combination of potential buyouts and rule changes that may facilitate an allocation satisfying each of the plurality of collateral allocation rules. In various embodiments, the Allocation Module 400 may receive and utilize one or more alternative rules identifying possible and impossible rule changes and/or buyouts. As a non-limiting example, the alternative rules may comprise a rule that a securitization structure cannot amend its collateral allocation rules.

In various circumstances, the Allocation Module 400 may determine that, under the present conditions of the collateral instruments 60 included in the CCASIA, there exists no possible changes that may facilitate an allocation in which each of the plurality of collateral allocation rules may be satisfied. In such instances, the Allocation Module 400 may be configured to transmit error data to the Notification and Alerts Module 500, which may be configured to cause a communication be sent to at least a portion of the affected parties and/or users of the system 100 described herein. In such circumstances, the Allocation Module 400 may be configured to await input from a user regarding instructions for proceeding. In various embodiments, the Allocation Module 400 may be configured to liquidate all collateral instruments included in the CCASIA. In such circumstances, the Allocation Module 400 may be configured to distribute the proceeds of the liquidation according to the debt products' pro rata shares.

In various embodiments, the Allocation Module 400 may be configured to receive updated collateral data from the Collateral Module 200 and/or updated debt product data from the Debt Product Module 300. In various embodiments, the Allocation Module 400 may be configured to receive updated data when the Collateral Module 200 and/or the Debt Product Module 300 “push” data to the Allocation Module 400. Alternatively, the Allocation Module 400 may be configured to periodically (e.g., every hour, day, week, month, and/or the like) check the other program modules in the computer system to determine whether updated data exists. As will be understood by those skilled in the art, the Allocation Module 400 may be configured to compare the collateral data and the debt product data upon receipt of updated data. Alternatively, the Allocation Module 400 may be configured to perform the comparison steps periodically (e.g., hourly, daily, weekly, monthly, and/or the like). In various embodiments, the Allocation Module 400 may be configured to compare a newly determined collateral allocation against the previously determined collateral allocation and transmit change data to the Notification and Alerts Module 500 in response to a determination that the most recently determined collateral allocation is not equivalent to the previously determined collateral allocation. In various embodiments, the change data may comprise data indicating the changes between consecutive collateral allocations, and may indicate affected debt products and shifted collateral instruments.

Notification and Alerts Module

In various embodiments, the Notification and Alerts Module 500 may be configured to generate and transmit communications to affected parties periodically (e.g., daily, weekly, monthly, and/or the like), or in response to the happening of a predetermined event. As illustrated at Blocks 501 and 502 of FIG. 10, Notification and Alerts Module 500 may be configured to receive input from the Allocation Module 400, the Collateral Module 200, and/or the Debt Product Module 300 regarding notifications to be transmitted to at least one party, and contact information data from the Debt Product Module 300, and may utilize this data in generating and transmitting notifications and alerts. As a non-limiting example, the Notification and Alerts Module 500 may be configured to generate and transmit an alert to a lending institution that is a party to an under-collateralized debt product. The Notification and Alerts Module 500 may be configured to receive error data, under-collateralization data, and/or other types of data from the Allocation Module 400, and in response to the receipt of such data, may generate and transmit a notification or alert to an impacted party.

As indicated at Block 503 of FIG. 10, the Notification and Alerts Module 500 may be configured to generate and send a notification to the collateral agent and/or servicer periodically, or in response to the occurrence of a specified event. The Notification and Alerts Module 500 may be configured to generate and send notifications and/or alerts to appropriate parties in response to a determination that the appropriate parties must take some action with respect to the CCASIA. As a non-limiting example, the Notification and Alerts Module 500 may be configured to generate and send a notification to a lending institution in response to a determination of a possible amendment to a collateral allocation rule included a credit agreement associated with the lending institution. Moreover, the Notification and Alerts Module 500 may be configured to notify the collateral agent and/or servicer when proceeds and/or distributions must be distributed according to the terms of the allocation data. In various embodiments, these notifications may be generated automatically, and may be generated periodically (e.g., weekly, monthly, and/or the like). The notifications informing the collateral agent and/or servicer of an impending distribution may indicate the appropriate amounts and appropriate parties to which to make the distributions.

In addition, the Notification and Alerts Module 500 may be configured to generate and transmit period reports to parties involved in the CCASIA. The reports may comprise information necessary to comply with applicable laws, rules, and/or regulations applicable to the various debt products and/or the CCASIA.

Exemplary Scenario

An exemplary scenario will now be provided. Although the following scenario provides specific information regarding a particular embodiment of the present invention, this information is presented as a non-limiting example only, and should not be interpreted to limit the scope of the invention.

In an exemplary embodiment Borrower A obtains a $100,000 loan from Lending Institution A that is secured by a universal life insurance policy. Borrower A and Lending Institution A agree to pledge the universal life insurance policy to a collateral account, define collateral eligibility requirements (including a minimum insurance carrier rating), and use an interest in the collateral account to secure the loan. At this point, Lending Institution A has a security interest in 100% of the collateral account. After the equity value of the universal life insurance policy increases to at least $400,000, Borrower A obtains a second $300,000 loan from Lending Institution B that is also secured by an interest in the collateral account and defines a second set of collateral eligibility requirements. At this point, the loan from Lending Institution A is now secured by a 25% interest in the collateral account, and the loan from Lending Institution B is now secured by a 75% interest in the collateral account. At some point, Borrower A may then negatively amortize the loan payments due, pledge additional collateral to the collateral account, and obtain a $10,000 loan from Lending Institution C that is likewise secured by an interest in the collateral account. At this point, the loan from Lending Institution A is secured by a 24.4% interest in the collateral account, the loan from Lending Institution B is secured by a 73.2% interest in the collateral account, and the loan from Lending Institution C is secured by a 2.4% interest in the collateral account. The insurance carrier is subsequently downgraded such that the universal life insurance policy is no longer eligible under the collateral eligibility criteria defined in the loan documentation associated with the loan from Lending Institution A. The $100,000 interest securing the loan from Lending Institution A may then be purchased by Lending Institution D, such that payments made by Borrower A in association with the $100,000 loan may then be directed to Lending Institution D.

Alternatively, upon the universal life insurance policy becoming ineligible under the terms of the loan from Lending Institution A, other lending institutions already having an interest in the collateral account may purchase the interest owned by Lending Institution A. Alternatively, Lending Institution A may grant an exception or amend the collateral eligibility requirement terms included in the associated agreement, and therefore continue to utilize the same interest to secure the loan to Borrower A.

Lending Institution E may extend a $50,000 loan to Borrower B secured by a mortgage backed security, and the parties may agree to pledge the mortgage backed security to the collateral account, define collateral eligibility criteria, and utilize a share in the collateral account to secure the loan. At this point, assuming the insurance carrier was not downgraded, the value of the collateral account is now $460,000, the loan from Lending Institution A to Borrower A is secured by a 21.7% interest in the collateral account, all of which is associated with the universal life insurance policy, the loan from Lending Institution B to Borrower A is secured by a 65.2% interest in the collateral account, all of which is associated with the universal life insurance policy, the loan from Lending Institution C to Borrower A is secured by a 2.2% interest in the collateral account, all of which is associated with the universal life insurance policy, and the loan from Lending Institution E to Borrower B is secured by a 10.9% interest in the collateral account, all of which is associated with the mortgage backed security. The universal life insurance carrier is then downgraded, such that it is no longer eligible under the collateral eligibility criteria associated with the $10,000 loan from Lending Institution C to Borrower A, however the mortgage backed security remain eligible under the terms of the same loan, and the universal life insurance policy remains eligible under the collateral eligibility criteria associated with the loan between Lending Institution E and Borrower B. The collateral is then shifted, Lending Institution A and Lending Institution B may maintain the same interests, but the loan from Lending Institution C to Borrower A is then secured by a $10,000 interest in the mortgage backed security, and the loan from Lending Institution E to Borrower B is then secured by a $40,000 interest in the mortgage backed security and a $10,000 interest in the universal life insurance policy. Although the collateral may have shifted, Borrower A and Borrower B retain the same repayment obligations under their respective loans.

Obligations of Collateral Agent

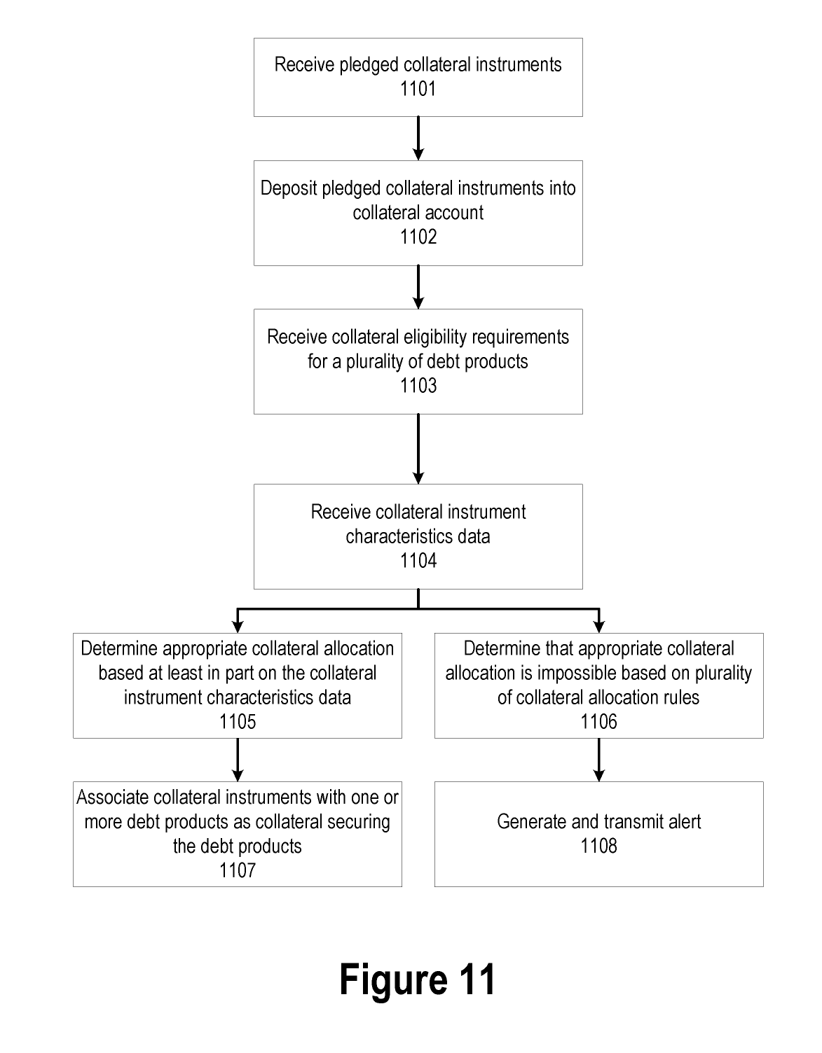

As illustrated in FIG. 11, the Collateral Agent 57 may complete a series of tasks in performing the duties associated with the position. Upon the formation of a CCASIA as described herein, parties associated with securitizations, and parties associated with credit agreements may pledge collateral instruments 60 to the collateral agent 57 for deposit into the collateral account 58. Thus, at Block 1101 of FIG. 11, the Collateral Agent 57 may receive the pledged collateral instruments 60. As shown at Block 1102 of FIG. 11, the collateral agent 57 may subsequently deposit the pledged collateral instruments 60 into the collateral account 58. As described herein, the collateral agent 57 may issue collateral account shares to the pledging entity in exchange for the pledged collateral instruments 60; the collateral account shares may entitle the holding entity (e.g., a lending institution or SPV) to a share of the assets held in the collateral account 58 equal in value to the collateral instruments 60 pledged by the associated party.

At Blocks 1103 and 1104 of FIG. 11, the collateral agent 57 may receive additional data associated with the collateral instruments pledged by a particular entity. At Block 1103, the collateral agent 57 may receive debt product data comprising collateral allocation rules applicable to the debt product associated with the pledged collateral instruments 60. At Block 1104, the collateral agent 57 may receive collateral data comprising characteristics of the pledged collateral instruments. At Blocks 1105 and 1106, the collateral agent 57 may determine whether an allocation of the pledged collateral instruments 60 may meet the collateral allocation requirements included in the received debt product data. Upon a determination that each collateral allocation rule may be satisfied, at Block 1107, the collateral agent associates each collateral instrument 60 with one or more debt products to act as collateral for the debt product. Upon a determination that each collateral allocation rule cannot be satisfied, at Block 1108 the collateral agent 57 may generate and transmit an alert to impacted parties. As described herein, the collateral agent 57 may additionally initiate an appropriate response in order to satisfy the collateral allocation rules.

Obligations of Servicer

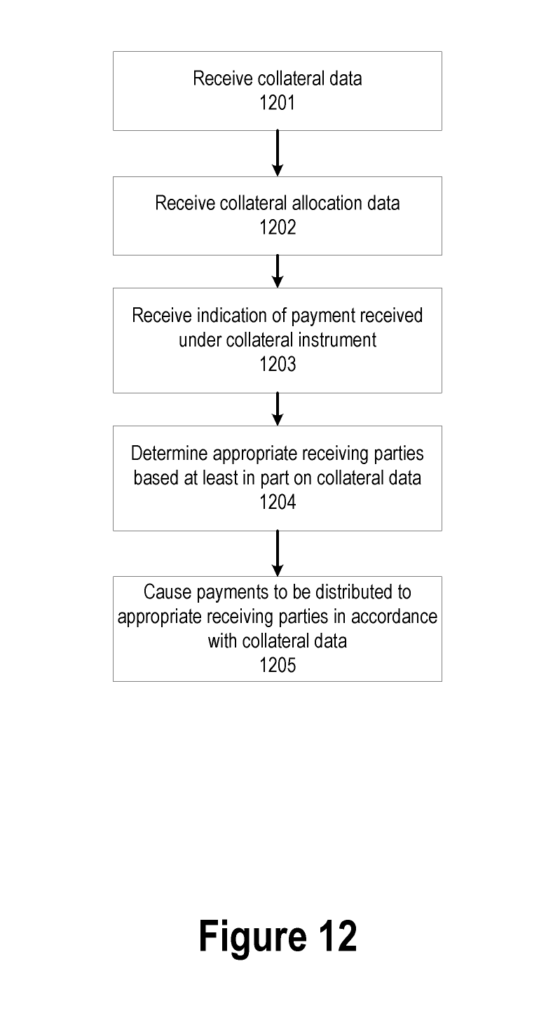

As illustrated in FIG. 12, the servicer 51a may accomplish a plurality of tasks in fulfilling the obligations of the position. As previously noted, the servicer 51a may receive and/or initiate distributions and/or payments from an obligor 50 under the terms of a collateral instrument 60 and may distribute and/or instruct appropriate parties to distribute these payouts to the appropriate entities having an interest in the collateral instrument 60. Therefore, as shown in FIG. 12, the servicer 51a may receive collateral data regarding those collateral instruments 60 from which the servicer 51a receives payments and/or distributions, at Block 1201. As noted, because the servicer 51a distributes payouts to parties having an interest in one or more collateral instruments 60, at Block 1202 of FIG. 12, the servicer 51a receives allocation data regarding the optimal allocation of collateral instruments 60 among a plurality of debt products associated with a CCASIA. At Block 1203 the servicer 51a receives an indication of payments received under a collateral instrument. The servicer 51a may utilize the allocation data at Block 1204 to determine the appropriate parties to which to distribute the payments and/or distributions. As described herein, the allocation data may specify which debt products have an interest in each collateral instrument 60, and the level of interest associated with each debt product. The servicer 51a may additionally utilize debt product data to determine the appropriate party to receive the distributions and/or payments to be distributed to each debt product. As a non-limiting example, the servicer 51a may utilize the collateral data to determine that a credit facility entered into between a borrower and a lending institution has a 10% interest in all distributions and/or payments arising from a particular collateral instrument. The servicer 51a may utilize the debt product data to determine that all distributions and/or payments received with respect to any associated collateral instruments are to be paid directly to the affected lending institution. Thus, in this exemplary situation, the servicer 51a may determine that 10% of the received distributions associated with the particular collateral instrument is to be distributed to the affected lending institution. Finally, at Block 1205, the servicer 51a may distribute or cause to be distributed the distributions and/or payments received from the collateral instrument 60.

### CONCLUSION

As will be understood by those skilled in the art, the embodiments described herein may provide a number of benefits over conventional collateral sharing agreements. A CCASIA according to various embodiments allows associated parties (e.g., lending institutions 53, borrowers 52, issuers 54, noteholders 54, and/or the like) to share the risk of an obligor default or prepayment under the terms of a collateral instrument. Because each debt product may specify individual collateral eligibility requirements, parties having an interest in a debt product may specify a particular level of risk to be associated with each debt product. Moreover, because the collateral instrument allocation may change over time, such that a particular debt product may only have an interest in a particular collateral instrument while that collateral instrument meets its collateral eligibility criteria, each debt product is only exposed to a risk of default and/or prepayment for those collateral instruments meeting the debt product's collateral eligibility criteria.

Various embodiments may also allow a larger pool of debt products to share collateral than conventional sharing arrangements. Whereas conventional collateral sharing arrangements require all collateral instruments to be specifically identified when the sharing arrangement is initiated, a CCASIA according to various embodiments may allow collateral instruments to be added or removed from the collateral account after the agreement is first executed. Consequently, a sharing arrangement utilizing a CCASIA according to various embodiments may exist for an indefinite amount of time, as collateral instruments may be added or removed after the account is first created. Although various debt products associated with a CCASIA may have a definite life (e.g., a credit facility may exist for a predefined number of years, or an asset backed security issued under a securitization agreement may receive payments for a predefined period of time), the collateral account may exist indefinitely, with additional debt products and collateral instruments be added after the account is first created.

Moreover, surrender rules established under the CCASIA may allow parties associated with a particular debt product to remove the debt product from the CCASIA without liquidating the entire collateral account. As discussed herein, parties remaining in the CCASIA after the removal of a particular debt product and associated collateral instruments may surrender a pro rata share in the removed collateral instruments, and a new collateral allocation may then be determined such that each remaining debt product remains adequately collateralized.

Many modifications and other embodiments of the inventions set forth herein will come to mind to those skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A computer-implemented method for managing a database of collateral data to reflect one or more allocations of collateral among at least two lenders, the method comprising steps for:
receiving debt product data for a plurality of debt products in a non-transitory memory, wherein the debt product data defines database management criteria for linking data stored in a database and wherein the database management criteria comprises:
data defining terms for sharing at least one collateral instrument among the plurality of debt products according to an initial allocation, the initial allocation defining an initial interest in at least a portion of the at least one collateral instrument in favor of at least a portion of the plurality of debt products; and
data defining allocation rules for each of the plurality of debt products, wherein the allocation rules define acceptable characteristics of collateral instruments;
receiving collateral data for one or more collateral instruments, wherein each of the one or more collateral instruments comprises a financial instrument under which an obligor agrees to make payments to satisfy a debt, and the financial instrument is secured by underlying collateral and the collateral data comprise characteristics of each of the one or more collateral instruments;
storing, via at least one computer processor, the collateral data in the database;
linking, via the at least one computer processor and based on the database management criteria, collateral data corresponding to the one or more collateral instruments with debt product data corresponding to one or more debt products for which the one or more collateral instruments satisfy corresponding allocation rules;
wherein data identifying the links between the collateral data and the debt product data are stored in the database and reflect an initial allocation of collateral instruments among the plurality of debt products; and
generating, via the at least one computer processor, allocation data based on the determined initial allocation, wherein the allocation data is indicative of links between collateral data associated with each of the one or more collateral instruments and debt product data associated with at least a portion of the debt products.

2. The method of claim 1, wherein the allocation data further defines collateral instrument interests for each debt product, the collateral instrument interests each define an interest level having a given value in at least one of the one or more collateral instruments to be utilized as collateral for the debt product.

3. The method of claim 1, further comprising steps for:
generating, via the at least one computer processor, at least one notification to be sent to at least one party based at least in part on the allocation data, the at least one notification comprising data regarding the collateral associated with at least one debt product.

4. The method of claim 2, further comprising steps for:
receiving updated collateral data for the one or more collateral instruments, wherein the updated collateral data comprise updated characteristics for each of the one or more collateral instruments;
updating, via the at least one computer processor, the collateral data to reflect the updated characteristics for each of the one or more collateral instruments;
updating, via the at least one computer processor and based at least in part on the database management criteria and the updated collateral data, the links between the collateral data corresponding to the one or more collateral instruments with debt product data corresponding to one or more debt products for which the one or more collateral instruments satisfy corresponding allocation rules;
wherein data identifying the updated links between the collateral data and the debt product data are stored in the database and reflect an updated allocation of collateral instruments among the plurality of debt products; and
generating, via the at least one computer processor, updated allocation data based on the updated allocation, wherein the updated allocation data is indicative of links between collateral data associated with each of the one or more collateral instruments and debt product data associated with at least a portion of the debt products.

5. The method of claim 2, wherein at least one of the plurality of debt products is selected from the group consisting of: (1) a credit facility and (2) a securitization structure, under the securitization structure the collateral instrument interest is used to secure an asset backed security, and a plurality of noteholders each have an interest in the asset backed security under which the plurality of noteholders receive at least a portion of payments collected under the terms of at least one collateral instrument associated with the collateral instrument interest.

6. The method of claim 2, further comprising steps for:
receiving, in the non-transitory memory, additional debt product data for at least one additional debt product, wherein the additional debt product data defines additional database management criteria for linking data stored in the database, and wherein the additional database management criteria comprises:
data defining terms for sharing the one or more collateral instruments with the plurality of debt products according to an updated allocation, the updated allocation defining a new interest in at least a portion of the at least one collateral instrument in favor of at least a portion of the plurality of debt products;
data defining additional allocation rules for the at least one additional debt product, wherein the additional allocation rules define acceptable characteristics of collateral instruments;
updating, via the at least one computer processor and based at least in part on the database management criteria and the additional debt product data, the links between the collateral data corresponding to the one or more collateral instruments with debt product data corresponding to one or more debt products for which the one or more collateral instruments satisfy corresponding allocation rules;
wherein data identifying the updated links between the collateral data and the debt product data are stored in the database and reflect an updated allocation of collateral instruments among the plurality of debt products; and
generating, via the at least one computer processor, updated allocation data based on the determined updated allocation, wherein the updated allocation data is indicative of links between collateral data associated with each of the one or more collateral instruments and debt product data associated with at least a portion of the debt products.

7. The method of claim 1, wherein the characteristics for each of the one or more collateral instruments comprise at least one of: a credit rating, a geographic location of underlying collateral; an obligor identity; a collateral type, and an insurance carrier associated with the underlying collateral.

8. The method of claim 2, wherein the debt product data further comprise collateralization requirements for each of the plurality of debt products, the collateralization requirements defining an aggregate collateral value that must be associated with the debt product; the method further comprising steps for:
determining, via the at least one computer processor, whether a debt product is under-collateralized based on the collateralization requirements of each debt product and the allocation data; and
generating, via the at least one computer processor, an alert in response to a determination that at least one of the plurality of debt products is under-collateralized.

9. The method of claim 2, wherein the debt product data further comprise collateralization requirements for each of the plurality of debt products, the collateralization requirements defining an aggregate collateral value that must be associated with the debt product; the method further comprising steps for:
determining, via the at least one computer processor, whether a debt product complies with applicable regulatory requirements may be embodied as a calculations, measurements, standards and monitoring of such data to determine lender capital requirements, borrower equity requirements, liquidity buffers and the like; and
generating, via the at least one computer processor, an alert in response to a determination that at least one of the plurality of debt products does not satisfy one or more regulatory requirements.

10. The method of claim 1, further comprising steps for:
determining, via the at least one computer processor, whether each collateral instrument is fully allocated among the plurality of debt products;
generating, via the at least one computer processor, an alert in response to a determination that at least one collateral instrument is not fully allocated among the plurality of debt products.

11. The method of claim 10, further comprising steps for generating, via the at least one computer processor, one or more repurchase options under which a party may agree to purchase the interest in at least one collateral instrument that is not fully allocated among the plurality of debt products.

12. The method of claim 1, further comprising steps for:
determining, via the at least one computer processor, whether the obligor has defaulted under terms of a collateral instrument and the underlying collateral associated with the financial instrument has been liquidated;
in the event that the underlying collateral associated with the collateral instrument has been liquidated, determining, via the at least one computer processor, based at least in part on the allocation data, a distribution by which to distribute at least a portion of the proceeds collected as a result of the liquidation, wherein the distribution is determined based at least in part upon a verification that all of the allocation rules are satisfied; and
via the at least one computer processor, causing at least a portion of the proceeds collected as a result of the liquidation to be distributed based at least in part on the distribution.

13. A system for allocating collateral associated with one or more debt products among a plurality of lenders, said system comprising:
one or more memory storage areas; and
one or more computer processors configured to:
receive debt product data for a plurality of debt products, wherein the debt product data defines database management criteria for linking data stored in a database and wherein the database management criteria comprises:
data defining terms for sharing at least one collateral instrument among the plurality of debt products according to an initial allocation, the initial allocation defining an initial interest in at least a portion of the at least one collateral instrument in favor of at least a portion of the plurality of debt products; and
data defining allocation rules for each of the plurality of debt products, wherein the allocation rules define acceptable characteristics of collateral instruments;
receive collateral data for the one or more collateral instruments, wherein each of the one or more collateral instruments comprises a financial instrument under which an obligor agrees to make payments to satisfy a debt, and the financial instrument is secured by underlying collateral, and the collateral data comprise characteristics of each of the one or more collateral instruments;
store the collateral data in the database;
link, based on the database management criteria, collateral data corresponding to the one or more collateral instruments with debt product data corresponding to one or more debt products for which the one or more collateral instruments satisfy corresponding allocation rules;
wherein data identifying the links between the collateral data and the debt product data are stored in the database and reflect an initial allocation of collateral instruments among the plurality of debt products; and
generate allocation data based on the determined initial allocation, wherein the allocation data is indicative of links between collateral data associated with each of the one or more collateral instruments and debt product data associated with at least a portion of the debt products.

14. The system of claim 13, wherein the allocation data further defines collateral instrument interests for each debt product, the collateral instrument interests each define an interest level having a given value in at least one of the one or more collateral instruments to be utilized as collateral for the debt product.

15. The system of claim 12, wherein the one or more computer processors are further configured to:
generate at least one notification to be sent to at least one party based at least in part on the allocation data, the at least one notification comprising data regarding the collateral associated with at least one debt product.

16. The system of claim 14, wherein the one or more computer processors are further configured to:
receive updated collateral data for the one or more collateral instruments, wherein the updated collateral data comprises updated characteristics for each of the one or more collateral instruments;
update the collateral data to reflect the updated characteristics for each of the one or more collateral instruments;
update, based at least in part on the database management criteria and the updated collateral data, the links between the collateral data corresponding to the one or more collateral instruments with debt product data corresponding to one or more debt products for which the one or more collateral instruments satisfy corresponding allocation rules;
wherein data identifying the updated links between the collateral data and the debt product data are stored in the database and reflect an updated allocation of collateral instruments among the plurality of debt products; and
generate updated allocation data based on the updated allocation, wherein the updated allocation data is indicative of links between collateral data associated with each of the one or more collateral instruments and debt product data associated with at least a portion of the debt products.

17. The system of claim 14, wherein at least one of the plurality of debt products is selected from the group consisting of: (1) a credit facility and (2) a securitization structure, under the securitization structure the collateral instrument interest is used to secure an asset backed security, and a plurality of noteholders each have an interest in the asset backed security under which the plurality of noteholders receive at least a portion of payments collected under the terms of at least one collateral instrument associated with the collateral instrument interest.

18. The system of claim 14, wherein the one or more computer processors are further configured to:
receive additional debt product data for at least one additional debt product, wherein the additional debt product data defines additional database management criteria for linking data stored in the database, and wherein the additional database management criteria comprises:
data defining terms for sharing the one or more collateral instruments with the plurality of debt products according to a new allocation, the new allocation defining a new interest in at least a portion of the at least one collateral instrument in favor of at least a portion of the plurality of debt products;
data defining additional allocation rules for the at least one additional debt product wherein the additional allocation rules define acceptable characteristics of collateral instruments;
update, based at least in part on the database management criteria and the additional debt product data, the links between the collateral data corresponding to the one or more collateral instruments with debt product data corresponding to one or more debt products for which the one or more collateral instruments satisfy corresponding allocation rules;
wherein data identifying the updated links between the collateral data and the debt product data are stored in the database and reflect an updated allocation of collateral instruments among the plurality of debt products; and
generate updated allocation data based on the determined updated allocation, wherein the new allocation data is indicative of links between collateral data associated with each of the one or more collateral instruments and debt product data associated with at least a portion of the debt products.

19. The system of claim 13, wherein the characteristics for each of the one or more collateral instruments comprise at least one of: a credit rating, a geographic location of underlying collateral; an obligor identity; a collateral type, and an insurance carrier associated with the underlying collateral.

20. The system of claim 14, wherein the debt product data further comprise collateralization requirements for each of the plurality of debt products, the collateralization requirements defining an aggregate collateral value that must be associated with the debt product; the one or more computer processors are further configured to:
determine whether a debt product is under-collateralized based on the collateralization requirements of each debt product and the allocation data; and
generate an alert in response to a determination that at least one of the plurality of debt products is under-collateralized.

21. The system of claim 13, wherein the one or more computer processors are further configured to:
determine whether each collateral instrument is fully allocated among the plurality of debt products;
generate an alert in response to a determination that at least one collateral instrument is not fully allocated among the plurality of debt products.

22. The system of claim 21, wherein the one or more computer processors are further configured to generate one or more repurchase options under which a party may agree to purchase the interest in at least one collateral instrument that is not fully allocated among the plurality of debt products.

23. The system of claim 13, wherein the one or more computer processors are further configured to:
determine whether the obligor has defaulted under terms of a collateral instrument and the underlying collateral associated with the financial instrument has been liquidated;
in the event that the underlying collateral associated with the collateral instrument has been liquidated, determine, based at least in part on the allocation data, a distribution by which to distribute at least a portion of the proceeds collected as a result of the liquidation, wherein the distribution is determined based at least in part upon a verification that all of the allocation rules are satisfied; and
causing at least a portion of the proceeds collected as a result of the liquidation to be distributed based at least in part on the distribution.

24. A non-transitory computer program product comprising at least one computer-readable storage medium having computer-readable program code portions embodied therein, the computer-readable program code portions comprising:
an executable portion configured for:
receiving debt product data for a plurality of debt products, wherein the debt product data defines database management criteria for linking data stored in a database and wherein the database management criteria comprises:
data defining for sharing one or more collateral instrument among the plurality of debt products according to an initial allocation, the initial allocation defining an initial interest in at least a portion of the at least one collateral instrument in favor of at least a portion of the plurality of debt products; and
data defining allocation rules for each of the plurality of debt products, wherein the allocation rules define acceptable characteristics of collateral instruments;
receiving collateral data for one or more collateral instruments, wherein each of the one or more collateral instruments comprises a financial instrument under which an obligor agrees to make payments to satisfy a debt, and the financial instrument is secured by underlying collateral and the collateral data comprise characteristics of each of the one or more collateral instruments;
storing, via at least one computer processor, the collateral data in the database;
linking, via the at least one computer processor and based on the database management criteria, collateral data corresponding to the one or more collateral instruments with debt product data corresponding to one or more debt products for which the one or more collateral instruments satisfy corresponding allocation rules;
wherein data identifying the links between the collateral data and the debt product data are stored in the database and reflect an initial allocation of collateral instruments among the plurality of debt products; and
generating allocation data based on the determined initial allocation, wherein the allocation data is indicative of links between collateral data associated with each of the one or more collateral instruments and debt product data associated with at least a portion of the debt products.
